(19) United States
(12) Patent Application Publication
(10) Pub. No.: US 2008/0314854 A1
(43) Pub. Date: Dec. 25, 2008

(54) Working Machine

(76) Inventors: Shouhei Kamiya, Ibaraki (JP); Hideo Sorata, Ibaraki (JP); Makoto Matsushita, Ibaraki (JP); Tsukasa Toyooka, Ibaraki (JP)

Correspondence Address: Mattingly, Stanger, Malur & Brundidge;John R. Mattingly, 1800 Diagonal Road, Suite 370, Alexandria, VA, 22314, US

(21) Appl. No.: 10/588,384

(22) PCT Filed: Mar. 22, 2005
(86) PCT No.: PCT/JP2005/005980

§ 371 Date: Aug. 2, 2006

(30) Foreign Application Priority Data
Mar. 30, 2004 (JP) 2004-100096
Mar. 30, 2004 (JP) 2004-100097

(51) Int. Cl. B66C 13/12

(52) U.S. Cl. 212/289

(57) ABSTRACT

The frame of a vehicle body is constituted by left and right vertical plates and a bottom plate coupling the vertical plates horizontally. In addition, a control valve device and a control valve device including a plural number of directional control valves are mounted in advance on a single mounting plate together with a correction lever, a plural number of operation levers and link mechanisms to obtain a lever/valve assembly. Then, the mounting plate constituting of the lever/valve assembly is attachable to or detachable from the left vertical plate of the frame by using bolts or the like. As a result, the efficiency of the assembly operation can be improved.

### TECHNICAL FIELD

The present invention relates to a working machine, such as a hydraulic excavator, a crane or a lift truck, and relates particularly to a working machine that is designed for the operation of a boom apparatus so called a front, operated by hydraulics to perform a construction or a loading operation.

### BACKGROUND ART

Generally, a working machine, such as a lift truck, is used for an operation (a loading operation) for delivering freight goods from the ground level to a higher level. Thus, a working machine of this type is constituted by a mobile vehicle frame and a telescopic boom apparatus, which is mounted on the rear portion of the frame so as to be capable of be lifted up and down, and which is extended or retracted by a hydraulic actuator for a boom (for example, Japanese Patent No. 2559831).

Further, the vehicle frame are provided for a directional control valve and operating lever. And the directional control valve is connected to the hydraulic actuator by a hydraulic pipe for performing the supply and discharge of pressure oil from a hydraulic source to the hydraulic actuator to control the operation of the boom apparatus, and the operation lever is manipulated manually for switching the directional control valve to control the supply and discharge of pressure oil relative to the hydraulic actuator.

Furthermore, as another prior art, a hydraulic excavator is well known wherein a boom apparatus is provided for the front portion of a revolving frame for digging into soil. In this case the revolving frame is provided a plural number of directional control valves and operating levers. And the directional control valves are connected to hydraulic actuators, and which control the operation of the boom apparatus by supplying and discharging pressure oil from the hydraulic source relative to the individual hydraulic actuators via a hydraulic pipe, and the operation levers are used to switch the individual directional control valves to control the supply and discharge of pressure oil relative to the individual hydraulic actuators (for example, Japanese Utility Model Laid-Open No. H 5-40360).

In addition, arranged between the operation levers and the directional control levers is a link mechanism provided as an operation transmission member. The link mechanism, for example, transmits to a directional control valve the force with which an operator manually inclines an operation lever, and changes the pertinent directional control valve.

Moreover, the plural number of directional control valves pile up each other and are assembled to constitute a single valve unit (multi-valve apparatus). A hydraulic pipe is connected to each directional control valve of this valve unit, so that the supply and discharge of pressure oil is performed for a plural number of hydraulic actuators, such as hydraulic cylinders.

According to the above described prior art, while assembling a working machine, a process for attaching directional control valves to a frame and a process for attaching operation levers are performed separately. Then, for example, while the directional control valves and the operation levers are separately assembled for the frame, a post-process is performed to couple these components using a link mechanism, etc.

Therefore, an assembling of the working machine becomes complicated, and it is difficult for the assembly process to be performed efficiently. Especially when the operation levers and the directional control valves are to be coupled by a link mechanism, the adjustment process for smoothly moving the link mechanism must be performed in a small work space provided within the vehicle body (frame). This contributes very much to the deterioration of the assembly work efficiency.

Furthermore, according to the above described arrangement used in the prior art, a plural number of directional control valves are piled up each other, and are assembled as a single valve unit (a multi-valve apparatus). Therefore, a plural number of hydraulic pipes, which connect a plural number of directional control valves to the individual hydraulic actuators, are intricately entangled around the valve unit, so that, a problem arises in that a great deal of time and labor are expended when connecting the hydraulic pipes.

Further, as the arrangement for a working machine, such as a lift truck, a boom apparatus that is to be operated by a hydraulic boom actuator is mounted at the rear portion of the frame of a vehicle body, while a stabilizer, which is operated by a hydraulic stabilizer actuator, is mounted at the front portion of the frame.

However, it is generally accepted that a directional control valve, which controls the hydraulic boom actuator, and a directional control valve, which controls the hydraulic stabilizer actuator, should be arranged as a single valve unit (a multi-valve apparatus) in the middle position of the longitudinal direction of the frame.

Therefore, a hydraulic pipe that connects the hydraulic boom actuator and the directional control valve must be extended rearward along the frame from the position of the valve unit. A hydraulic pipe that connects the hydraulic stabilizer actuator and the directional control valve must also be extended forward along the frame, and a problem encountered is that the works for arrangement of the hydraulic pipes and a pipe connection become complicated.

In addition, as the hydraulic pipes are extended, en route, portions of the pipes tend to slacken. Then, in order to prevent the slackening of the hydraulic pipes, hooks for the hydraulic pipes must be provided, en route, at portions of the hydraulic pipes in the longitudinal direction. As a result, a problem arises in that the number of parts is increased and in that more labor is required for the operation performed to arrange the hydraulic pipes, and thus, the efficiency of the assembly work is deteriorated.

### DISCLOSURE OF THE INVENTION

While taking the above described prior art problems into account, the objective of the present invention is to provide a working machine for which works for the assembly of a directional control valve and an operation lever on a frame can be efficiently performed, and thus, the efficiency of the assembly work can be improved.

Further, another objective of the present invention is to provide a working machine for which the length of a hydraulic pipe that connects a directional control valve and a hydraulic actuator can be shortened and a hydraulic piping operation and a connection operation can be simplified, and for which the number of parts can be reduced and the efficiency of the assembly work improved.

(1) To achieve the above described objectives, the present invention is applied for a working machine comprised of a frame constituting a mobile vehicle body and extending from the front to the rear, a boom apparatus provided for the frame and operated by a plural number of hydraulic boom actuators, a plural number of directional control valves controlling an operation of the boom apparatus by supply or discharge of pressure oil relative to the individual hydraulic actuators, a plural number of operation levers switching the individual directional control valves in order to control the supply and discharge of pressure oil, relative to the individual hydraulic actuators.

The characteristic of a configuration adopted by the present invention is that the individual operation levers and the directional control valves are mounted to a single bracket to construct a lever/valve assembly, and the lever/valve assembly is mounted to be attachable to or detachable from the frame by use of the bracket which is a constituent of the lever/valve assembly.

As described above, according to this invention, the operation levers and the directional control valves are assembled in advance and attached to a single bracket, which constitutes the lever/valve assembly. Therefore, only the bracket of the lever/valve assembly need be attached to the frame of the vehicle body, for the operation levers and the directional control valves to be collectively assembled on the frame. Thus, the assembly operation can be efficiently performed, and the work efficiency during the processing for assembling a working machine can be improved. In addition, confirmation for the operating state of the directional control valves, relative to the operation levers, can be easily performed when the lever/valve assembly is preliminarily constructed. And after the fine adjustment for movements of the directional control valves have been completed, the operation during which the bracket is used to attach to the frame can be smoothly performed.

(2) Further, according to the arrangement of the invention, the base end of the boom apparatus is provided liftably up and down at the rear portion of the frame, a stabilizer apparatus which is to be operated by a hydraulic stabilizer actuator is provided at the front portion of the frame, the directional control valves which control the boom hydraulic actuators are located at the rear portion of the bracket in the vicinity of the position whereat the boom apparatus is mounted, and a directional control valve which controls the hydraulic stabilizer actuator is located in front of the bracket in the vicinity of the position whereat the stabilizer apparatus is attached.

In this case, of the plural number of directional control valves provided for the working machine, the directional control valves used for the boom which control the hydraulic boom actuators can be located at the rear side of the bracket that is near the position whereat the boom apparatus is mounted. The directional control valve for the stabilizer which controls the hydraulic stabilizer actuator can be located at the front side of the bracket that is near the position whereat the stabilizer apparatus is attached. And when the directional control valves used for the boom are employed to control the supply and discharge of pressure oil, relative to the hydraulic boom actuators, the boom apparatus can be controlled at the rear portion of the frame and can be lifted up and down. In addition, when the directional control valve used for the stabilizer is employed to control the supply and discharge of pressure oil, relative to the hydraulic stabilizer actuator, the stabilizer apparatus can be operated at the front portion of the frame, and the state in which the vehicle body is stabilized can be maintained.

Furthermore, the lengths of the hydraulic pipes that connect the directional boom control valves and the hydraulic boom actuators can be shorter than those of the prior arts. Also the length of the hydraulic pipe that connects the directional control stabilizer valve and the hydraulic stabilizer actuator can be shortened. As a result, the works of the hydraulic piping which are provided for the directional control valves used for the boom and the stabilizer and the connection work can be simplified. Further, since the hydraulic pipes can be shortened hooks or the like for the pipes are not required en route, in the longitudinal direction of each hydraulic pipe portions, and the number of parts can be reduced and the work efficiency for the vehicle assembly process, including that for the hydraulic piping operation, can be increased.

(3) In addition, according to the arrangement of the invention, a tilt correction hydraulic cylinder is provided on the front side of the frame in order to correct the left or right tilting of the vehicle body, and a directional control valve controlling the tilt correction hydraulic cylinder is located in front of the bracket.

With this arrangement, the directional control valve, which controls the supply and discharge of pressure oil, relative to the tilt correction hydraulic cylinder, can be positioned at a location at the front portion of the vehicle body and near the tilt correction hydraulic cylinder. Also, the length of the hydraulic pipe can be reduced.

(4) Moreover, according to the arrangement of the invention, the lever/valve assembly includes an operation transmission member attached to the bracket and located between the operation levers and the directional control valves, and the operation transmission member couples the operation levers with the directional control valves to transmit the operation force of the operation levers toward the directional control valves.

As described above, the operation transmission member, which transmits the operating force of the operation levers to the directional control valves, is positioned between the operation levers and the directional control valves, and attached in advance to the bracket. With this arrangement, adjusting works for transmitting the smooth movements of the operation transmission member (e.g., a link mechanism or the like) and the directional control valves, can be easily performed during the process for assembling the lever/valve assembly, while obtaining a much space. Further, after the fine adjustment of the movements of the directional control valves has been completed, the attachment of the lever/valve assembly to the frame by using the bracket can be smoothly performed. Further, since the operation transmission member is attached to a single bracket together with the operation levers and the directional control valves for a constituent of the lever/valve assembly, the entire lever/valve assembly which includes the directional control valves can be made compactly, and assembly errors can be reduced.

(5) Furthermore, according to the invention, the frame is constituted by a pair of vertical plates which are separated to the left and right sides and extend from the front to the rear directions, and a bottom plate which couples the pair of vertical plates in the left and right direction, and the lever/valve assembly is attached to one of the pair of vertical plates. With this arrangement, the bracket of the lever/valve assembly can be transversely (from the left to the right) attached to the inner side wall of one of the vertical plates using bolts or the like, and the assembly work efficiency can be improved.

(6) Further, according to the arrangement of the invention, an operator cab used when manipulating the operation levers is provided for one of the vertical plates to which the lever/valve assembly is attached. Therefore, as an example, while positioned at a driver's seat in the cab, an operator can switch the directional control valves by manually inclining the operation levers, and can smoothly control (operate) the supply and discharge of pressure oil to the hydraulic actuators.

(7) In addition, according to the arrangement of the invention, a lock mechanism restricting the control of the operation levers is provided for the bracket of the lever/valve assembly. With this arrangement, since the lock mechanism can be included in the lever/valve assembly constituted by the operation levers and the directional control valves, the entire unit can be compactly made. Further, when the lock mechanism is operated, erroneous manipulation of the operation levers is prevented, operational safety is ensured, and reliability is improved.

(8) Moreover, according to the arrangement of the invention, a plural number of link mechanisms having a plural number of support pins are provided for the bracket between each of the operation levers and each of the directional control valves, and the support pins rotatably support a plural number of link members which transmit the operating force of the operation levers to the directional control valves. The support pins of the individual link mechanisms have an axial length equivalent to a length that permits a plural number of the link members to be inserted in a row in an axial direction, and are constituted as common support pins used in common to support one or a plural number of the link members.

With this arrangement, when, for example, the individual link mechanisms are to be assembled by using a plural number of common support pins, one usage form wherein a plural number of link members are inserted in a row, in the axial direction of the pin, can be employed for a specific common support pin. On the other hand, another usage form wherein one link member is shifted to one side or the other side in the axial direction and inserted can be employed for the other common support pin. And when the link mechanisms are used to couple the directional control valves and the operation levers of the working machine, the multiple support pins can be employed as common parts, for example, for the two described above usage forms, so that a plural number of support pins having different lengths need not be prepared in advance.

Therefore, since a single support pin is employed as a common part, the number of parts can be reduced and parts management can be simplified. Further, since multiple common support pins are used in common, erroneous assembly of the support pin can be avoided, extra labor and time for the attachment of the common support pins are not required, and the work efficiency for the assembly operation can be improved. Furthermore, by employing common support pins that are common pairs, the heights whereat the individual link member are attached can differ from each other, so that the interference with each link members can be easily prevented. Further, by using these link mechanisms, manipulation of the operation levers can be smoothly transmitted to the directional control valves and the others, operational safety is ensured and reliability can be improved.

(9) In addition, according to the arrangement of the invention, the bracket constituting of the lever/valve assembly is provided with a plural number of signal output means for outputting signals consonant with manipulation of the individual operation levers, and a plural number of signal transmission means for transmitting signals from the respective signal output means to the directional control valves and for switching the directional control valves individually.

With this arrangement, when one of the plural number of operation levers is inclined, a signal consonant with the manipulation of the operation lever is output by corresponding signal output means, and the signal transmission means transmits this signal to the directional control valve to change the directional control valve. In this case, the plural number of operation levers, the signal output means and the signal transmission means need only be assembled with the bracket together with the first and the second directional control valves to constitute a lever/valve assembly. As a result, by using the bracket, the lever/valve assembly can be collectively attached, for example, to the vertical plates of a frame. Therefore, the work efficiency of the assembly operation can be improved.

### BRIEF DESCRIPTION OF THE DRAWINGS

In the accompanying drawings:

FIG. 1 is a perspective view of a lift truck according to a first embodiment of the present invention;

FIG. 2 is a front view of the lift truck in FIG. 1;

FIG. 3 is a plan view of the lift truck in FIG. 1;

FIG. 4 is a perspective view of the frame of a vehicle body, a lever/valve assembly, and so on, when front wheels, rear wheels, a body stabilization apparatus are removed in FIG. 1;

FIG. 5 is a top plan view of the frame, the lever/valve assembly in FIG. 4;

FIG. 6 is an essential enlarged diagram showing the lever/valve assembly in FIG. 5;

FIG. 7 is a cross-sectional view of the lever/valve assembly taken in a direction indicated by an arrow VII-VII in FIG. 6;

FIG. 8 is a perspective view of the state wherein the lever/valve assembly is attached to the left vertical plate of the frame;

FIG. 9 is an enlarged front view of the lever/valve assembly in FIG. 8;

FIG. 10 is a front view of the lever/valve assembly in FIG. 9 as a single unit;

FIG. 11 is a perspective view of the lever/valve assembly showing FIG. 10;

FIG. 12 is a partially enlarged diagram showing the link mechanism of the lever/valve assembly in FIG. 10;

FIG. 13 is an enlarged cross-sectional view of the common support pin, the rotary members and the spacers of the link mechanism taken in a direction indicated by an arrow XIII-XIII in FIG. 12;

FIG. 14 is a left side view of the common support pin, the rotary members and the spacers of the link mechanism taken in a direction indicated by an arrow XIV-XIV in FIG. 13;

FIG. 15 is a cross-sectional view of the common support pin, the rotary members and the spacers of the link mechanism taken in a direction indicated by an arrow XV-XV in FIG. 13;

FIG. 16 is an external appearance diagram showing the common support pin in FIG. 15 as a single unit;

FIG. 17 is an enlarged cross-sectional view of the link mechanism on the correction lever side taken in a direction indicated by an arrow XVII-XVII in FIG. 12;

FIG. 18 is an enlarged cross-sectional view of the common support pin, the rotary members and the spacers of the link mechanism taken in a direction indicated by an arrow XVIII-XVIII in FIG. 12;

FIG. 19 is an enlarged cross-sectional view of the link mechanism on the operation lever side taken in a direction indicated by an arrow XIX-XIX in FIG. 12;

FIG. 20 is an enlarged cross-sectional view of the common support pin, the rotary members and the spacers of the link mechanism taken in a direction indicated by an arrow XX-XX in FIG. 12;

FIG. 21 is a hydraulic circuit diagram showing a hydraulic pump, a plural number of directional control valves, the individual cylinders of a boom apparatus and so forth;

FIG. 22 is a front view of a lever/valve assembly according to a second embodiment of the invention; and

FIG. 23 is an external appearance diagram showing a common support pin according to a modification.

### BEST MODE FOR CARRYING OUT THE INVENTION

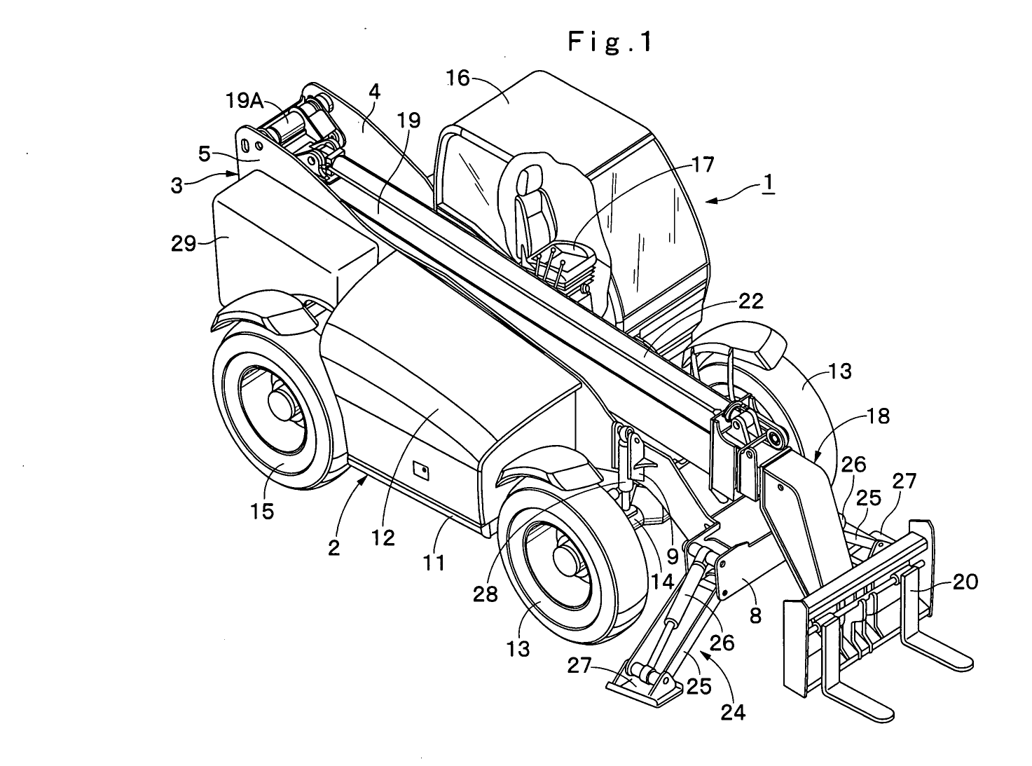

While referring to FIGS. 1 to 22, a detailed explanation will now be given for an example wherein a working machine according to the embodiment of the present invention is applied for a lift truck.

FIGS. 1 to 21 show a first embodiment of the present invention. In the drawings, reference numeral 1 denotes a lift truck used as a working machine, and the lift truck 1 is roughly constituted by a vehicle body 2 of a mobile wheel type, and a boom apparatus 18 that will be described after. The lift truck 1 employs the boom apparatus 18 to deliver freight goods from ground level to an elevated position, for example, after arriving at a job site by self-propulsion.

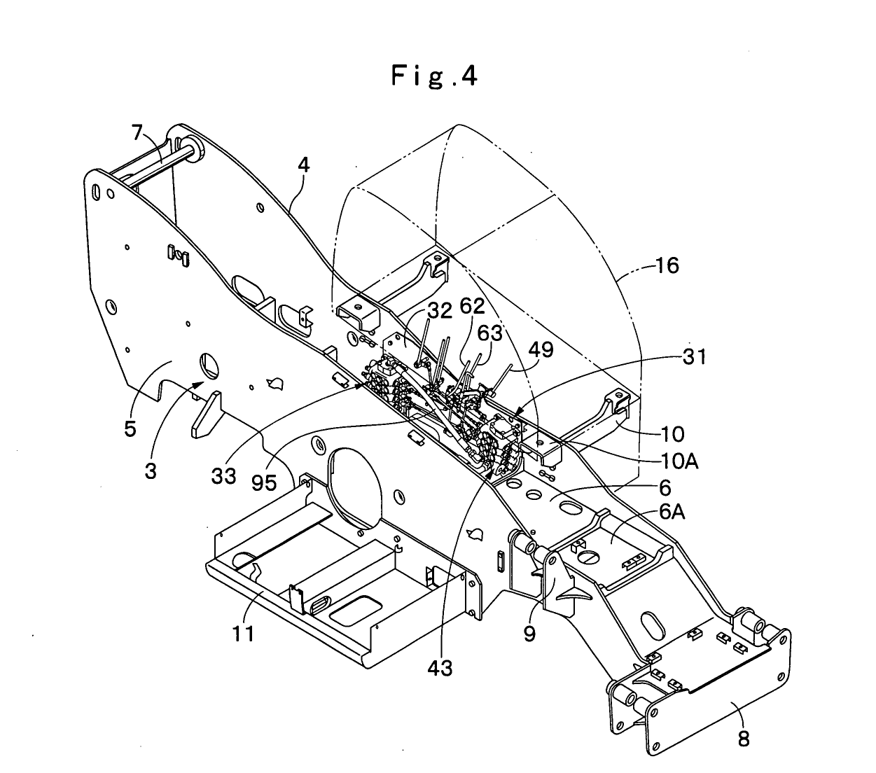

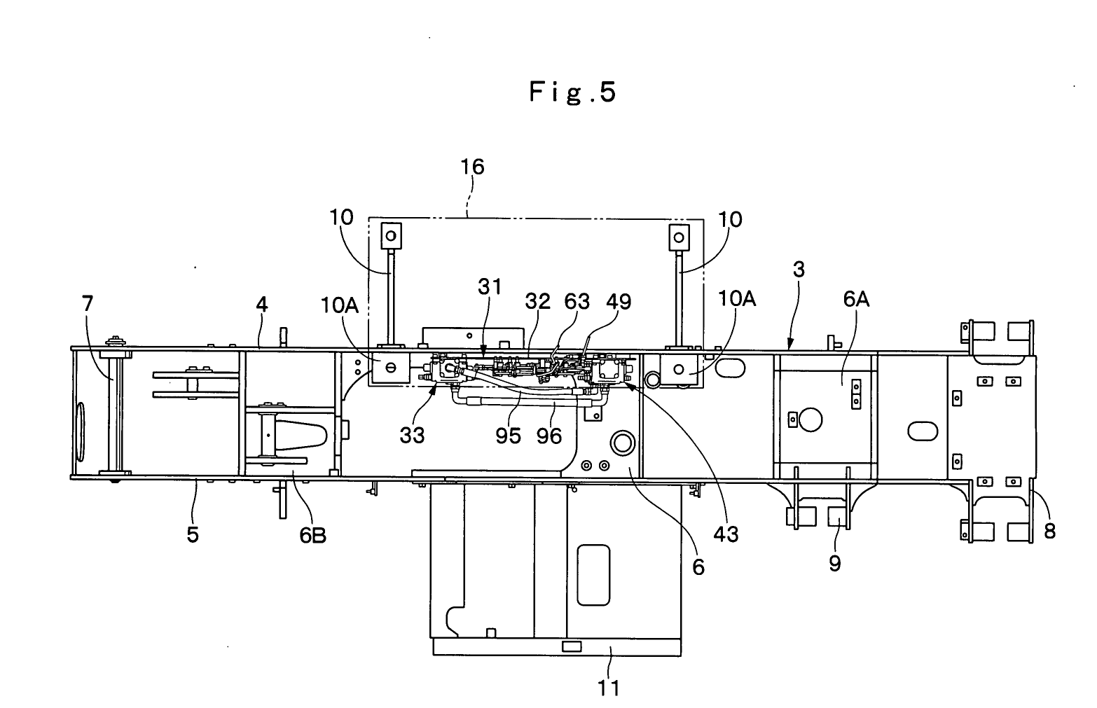

Reference numeral 3 denotes a frame constituting the base of the vehicle body 2. As shown in FIGS. 4 and 5, this frame 3 serves as a firm support structure member by employing, for example, a pair of vertical plates 4, 5 (a left vertical plate 4, a right vertical plate 5), which are formed of thick steel plates, and which are separated to the left and right sides and extended to the front and rear direction, and a bottom plate 6, which is formed of a thick plate same as the vertical plates 4, 5, and which couples (bonds) the vertical plates 4, 5 horizontally.

A front wheel support portion 6A for supporting individual front wheels 13, which will be described after, is provided at the front portion of the bottom plate 6, while a rear wheel support portion 6B for supporting individual rear wheels 15, which will be described after, is provided at the rear portion of the bottom plate 6. Further, at the rear portion of the frame 3, a coupling pin 7 is provided between the left vertical plate 4 and the right vertical plate 5 for liftably mounting a boom 19 of the boom apparatus 18, which will be described after.

Reference numeral 8 denotes a stabilizer mounting portion, provided at the front end side of the frame 3. As shown in FIGS. 1 to 3, stabilizers 25, which will be described after, are connected to the stabilizer mounting portion 8 by pins to be extendable horizontally. Further, a cylinder mounting portion 9 is provided for the right vertical plate 5 of the frame 3. The cylinder mounting portion 9 is located between the stabilizer mounting portion 8 and a device support portion 11, and at a position consonant with the front wheel support portion 6A. The tilt correction cylinder 28, which will be described after, is to be connected by pins to the cylinder mounting portion 9.

Reference numerals 10, 10 denote cab support portions provided for the left vertical plate 4 of the frame 3, and as shown in FIGS. 4 and 5, the cab support portions 10, 10 are extended to the left (outwardly) from the middle of the external side face of the left vertical plate 4 to the front and rear directions. Through the left vertical plate 4 of the frame 3, a cab 16, which will be described after, is supported by the individual cab support portions 10 and support seats 10A provided on the inner side face of the left vertical plate 4.

Reference numeral 11 denotes a device support portion provided at the middle portion of the right vertical plate 5 to the front and rear directions. The device support portion 11 is projected to the right from the right vertical plate 5, and supports an engine as a prime mover, a radiator as a heat exchanger and other devices (not shown) from below. As shown in FIG. 1, a device cover 12 is mounted on the device support portion 11, and is opened or closed for protection and maintenance of the engine.

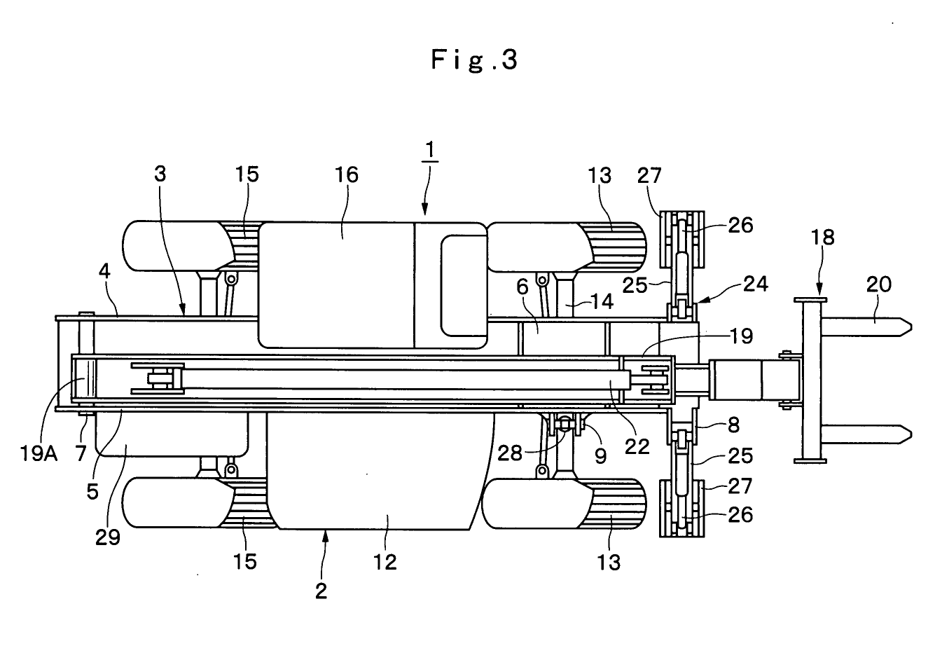

Reference numerals 13, 13 denote left and right front wheels, rotatably provided for the front portion of the frame 3 by an axle housing 14. As shown in FIGS. 1 and 3, the left and right front wheels 13, 13 are rotatably mounted at the left and right ends of the axle housing 14 by vehicle shafts. When a rotational drive force powered by a hydraulic motor (not shown) is transmitted by the vehicle shaft, the left and right front wheels 13 together with the rear wheels 15 move the vehicle body 2. Further, the left and right front wheels 13 and the rear wheels 15 are all driven as a four-wheel drive guided by a steering handle (not shown) that is provided in the cab 16, which will be described after, so that the direction of travel of the vehicle body 2 can be controlled.

The axle housing 14 is mounted by use of support pins (not shown) on the lower face of the front wheel support portion 6A, so that the axle housing 14 is horizontally displaceable relative to the bottom plate 6 of the frame 3. The axle housing 14 has a function to correct the horizontal tilt of the frame 3 of the lift truck 1 in cooperation with the tilt correction cylinder 28, which will be described after.

Reference numerals 15, 15 denote left and right rear wheels rotatably mounted on the rear portion of the frame 3 through the axle housing. These left and right rear wheels 15 are also rotatably attached to the left and right ends of the axle housing by the vehicle shafts. In this case, the axle housing on the rear wheel side is also movably supported by the rear wheel support portion 6B of the bottom plate 6 by support pins (not shown). Then, a rotational drive force powered by the hydraulic motor for driving is transmitted by the vehicle shaft, and the left and right rear wheels drive the vehicle body 2 together with the front wheels 13. Further, the left and right rear wheels 15 and the front wheels 13 as a four-wheel drive are guided by the handle to control the direction of travel of the vehicle body 2.

Reference numeral 16 denotes a cab that constitutes the operating section of the lift truck 1. As indicated by a chain double-dashed line in FIGS. 4 to 7, the cab 16 is mounted on the left vertical plate 4 of the frame 3 by the cab support portion 10, and internally defines an operation chamber. Inside the cab 16 an operator's seat 17 on which an operator sits, the handle (not shown) for steering, a correction lever 49, operation levers 51, 52, 55, 62 and 63 are provided, which will be descried after.

Reference numeral 17 denotes an operator's seat arranged in the cab 16. As shown in FIG. 1, the operator's seat 17 is mounted on the left vertical plate 4 of the frame 3 through the floor plate (not shown) of the cab 16. An operator who gets in and out of the cab 16 manually inclines the operation levers 51, 52, 55, 62 and 63, which will be described after, while the still in the operator's seat 17.

Reference numeral 18 denotes a boom apparatus for loading work that is provided liftably up and down on the rear side of the vehicle body 2. As shown in FIG. 1, the boom apparatus 18 is roughly constituted by a boom 19 consisting a boss 19A at the base end that is liftably coupled with the rear upper end of the frame 3 (the vertical plates 4, 5) by the coupling pin 7 (see FIG. 4), and which is extended to the front and rear directions, and a fork 20 which serves as freight goods working tool that is rotatably mounted at the distal end of the boom 19.

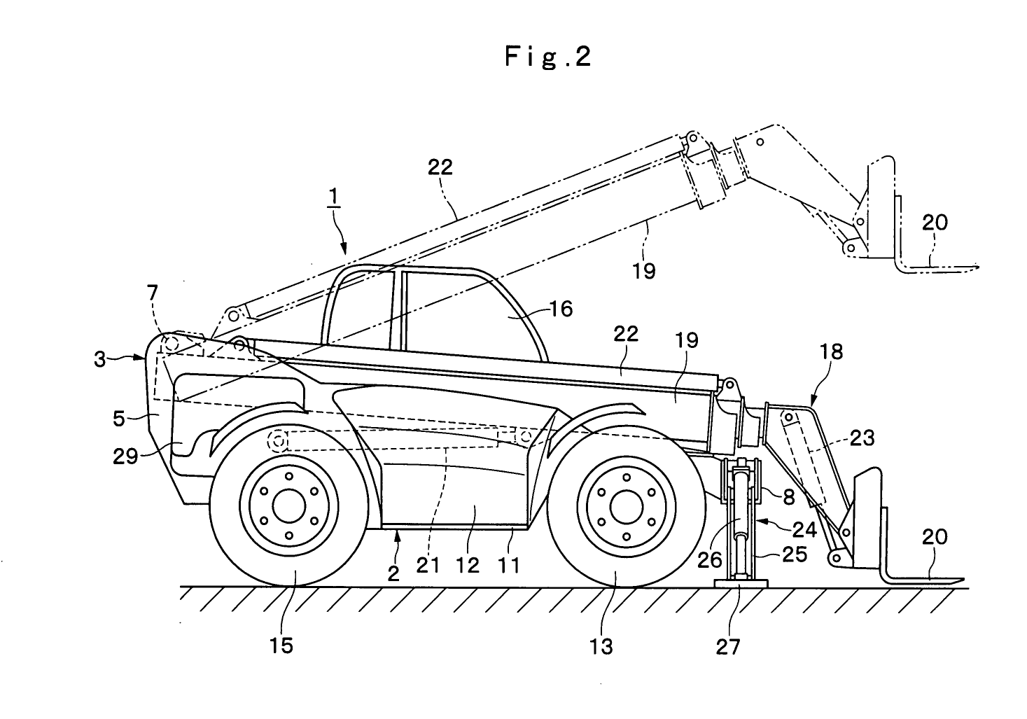

Further, the boom 19 is constituted by a telescopic boom consisting of a plural number of steps (e.g., three steps). Furthermore, as indicated by a broken line in FIG. 2, a boom derricking cylinder 21 is located between the frame 3 and the boom 19. When the supply and discharge of pressure oil is performed by a hydraulic pump 97, which will be described after, through a directional control valve 36, the boom derricking cylinder 21 vertically lifts up and down the boom 19 with the coupling pin 7 in FIG. 2 as the center.

Reference numeral 22 denotes a boom extension cylinder provided for the boom apparatus 18. As shown in FIGS. 1 to 3, the boom extension cylinder 22 is located outside the boom 19, and extends or retracts the above described telescopic boom 19 in the longitudinal direction. In addition, a fork cylinder 23 (see FIG. 2) which serves as a work tool cylinder is located between the distal end of the boom 19 and the fork 20. The fork cylinder 23 is used to vertically turn the fork 20 at the distal end of the boom 19.

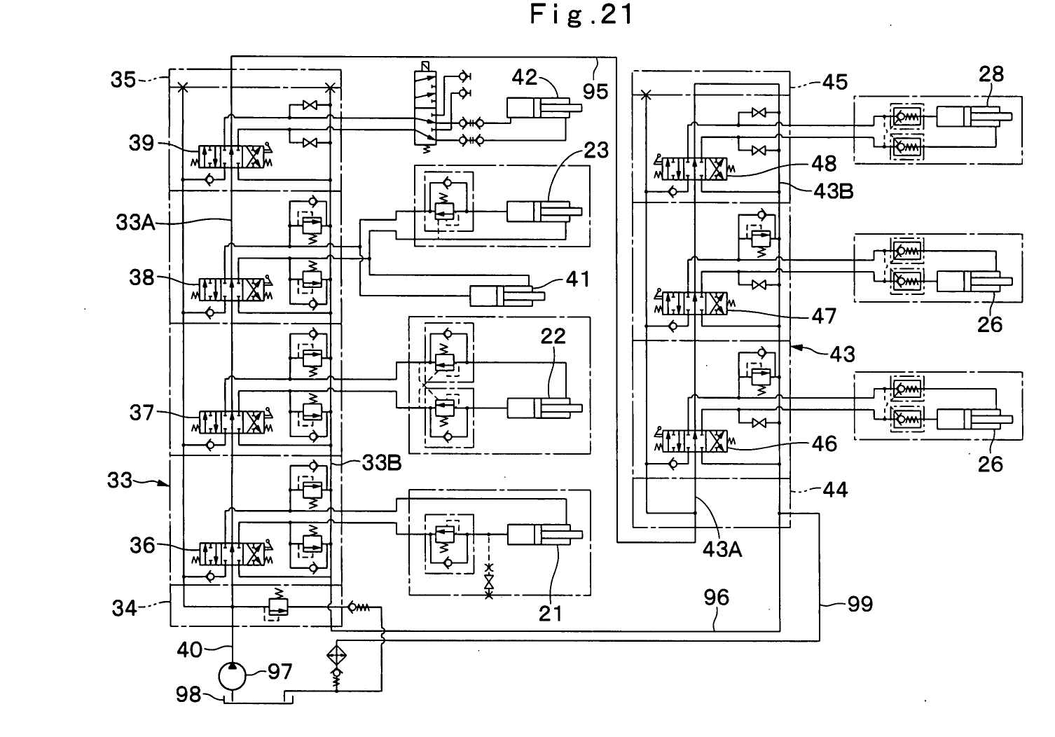

In this case, the boom derricking cylinder 21, the boom extension cylinder 22 and the fork cylinder 23 constitute a boom hydraulic actuator that operates the boom apparatus 18. These cylinders 21, 22, 23 are extended or retracted by performing the supply or discharge of pressure oil from the hydraulic pump 97 through directional control valves 36, 37, 38 as shown in FIG. 21, which will be described after.

Reference numeral 24 denotes a body stabilization apparatus provided at the front portion of the vehicle body 2. As shown in FIG. 1, the body stabilization apparatus 24 includes left and right stabilizer devices 25, 25 which are attached to the stabilizer mounting portion 8 of the frame 3, and the tilt correction cylinder 28 which corrects left and right inclinations of the vehicle body 2.

The left and right stabilizers 25, 25 (hereinafter referred to as stabilizers 25) are constituted by stabilizer cylinders 26, 26, which serve as left and right stabilizer hydraulic actuators that are mounted on the front portion of the frame 3 through the stabilizer mounting portion 8, and left and right ground plates 27, 27, which contact the ground.

During a loading operation by use of the boom apparatus 18, as shown in FIG. 1, the stabilizers 25 is extended from the stabilizer mounting portion 8 to the left and the right by the stabilizer cylinders 26, and the ground plates 27 contact the ground. Further, when the stabilizer cylinders 26 are retracted, the ground plates 27 of the stabilizers 25 are lifted vertically, high off the ground, to prevent the stabilizers 25 from interrupting the travel of the vehicle.

Reference numeral 28 denotes a tilt correction hydraulic cylinder (hereinafter referred to as a tilt correction cylinder 28) that is mounted on the right vertical plate 5 of the frame 3 through the cylinder mounting portion 9. As shown in FIG. 1, the tilt correction cylinder 28 abuts upon the axle housing 14 on the front wheel 13 side so as to be able to be extended and retracted, and performs a correction (a frame leveling) for the left and right tilting of the frame 3.

That is, when the lift truck 1 is halted, for example, on a slope (e.g., a slope whereon a vehicle is inclined to the left or right), the frame 3 of the vehicle body 2 may be inclined to the left or right together with the axle housing 14 on the front wheel 13 side. However, in this case, the axle housing 14 is attached through the support pins to the front wheel support portion 6A of the bottom plate 6 so as to be rotatable horizontally.

Therefore, the tilt correction cylinder 28 need only be appropriately extended or retracted between the frame 3 and the axle housing 14, and the tilting of the vehicle body 2 can be corrected so that the frame 3 (the bottom plate 6) of the vehicle body 2 is horizontal relative to the axle housing 14 which is inclined on the slope.

As described above, during a loading operation (when a vehicle is halted), the body stabilization apparatus 24 employs the stabilizer cylinders 26 to extend the stabilizers 25 to the left and to the right and bring the ground plates 27 into contact with the ground, and employs the tilt correction cylinder 28 to correct the tilting of the vehicle body 2. In this manner, preventing the overturning of the vehicle body 2 is aimed at.

Reference numeral 29 denotes a fuel tank that is provided at the rear portion of the frame 3, as shown in FIG. 1. The fuel tank 29 is mounted, from the side, at the rear portion of the right vertical plate 5 which serves as a part of the frame 3. And the fuel tank 29 is provided as a hollow container that is made, for example, of a very strong synthetic resin material and has almost a rectangular shape, and is used to supply fuel to the engine of the device cover 12.

Next, reference numeral 31 denotes a lever/valve assembly adopted for this embodiment. As shown in FIGS. 4 to 11, the lever/valve assembly 31 is constituted by a mounting plate 32 which will be described after, a first control valve device 33 (directional control valves 36 to 39), a second control valve device 43 (directional control valves 46 to 48), a correction lever 49, a link mechanism 50, operation levers 51, 52, 55, 62, 63, and link mechanisms 53, 54, 56, 59 to 61.

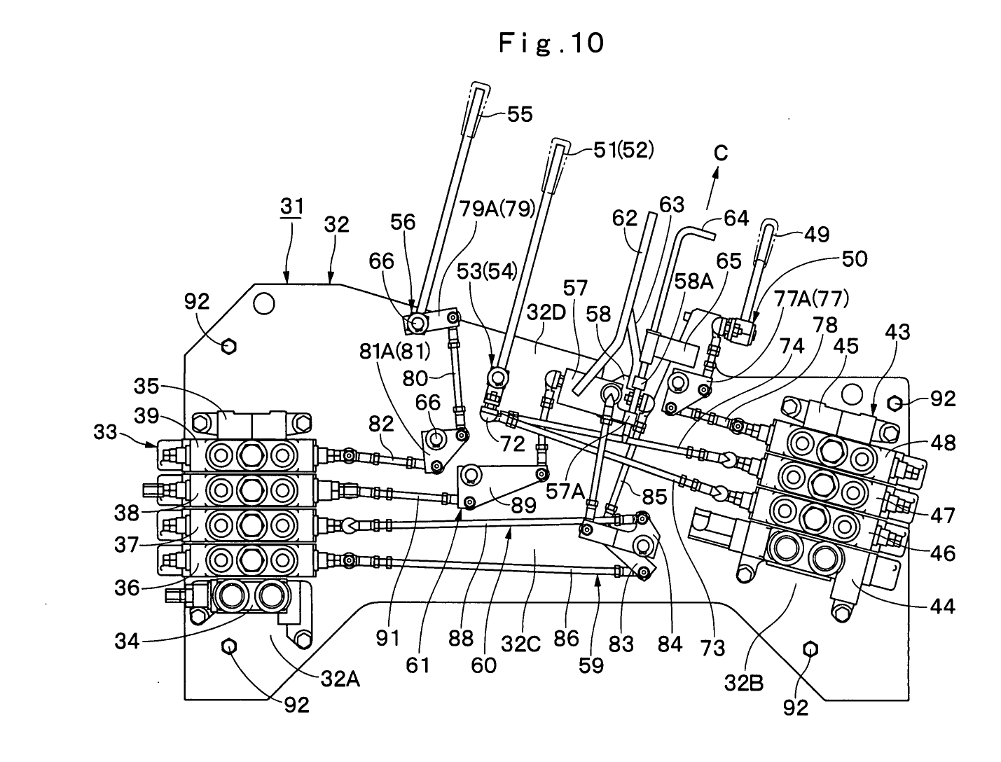

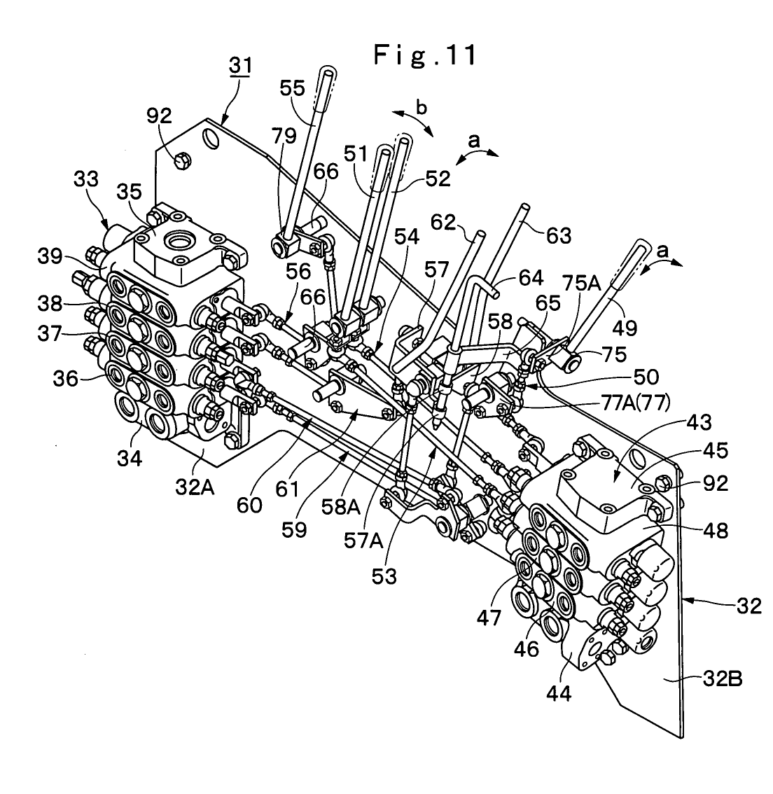

And as shown in FIGS. 10 and 11, while the control valve devices 33, 43, the correction lever 49, the link mechanism 50, the operation levers 51, 52, 55, 62, 63, the link mechanisms 53, 54, 56, 59 to 61 are mounted in advance on the mounting plate 32, the lever/valve assembly 31 can be attached to or detached from the left vertical plate 4 of the frame 3 by using the mounting plate 32.

In this case, as shown in FIGS. 4 to 7, the correction lever 49 and the operation levers 51, 52, 55, 62, 63 of the lever/valve assembly 31 are located so as to be projected from the upper end of the mounting plate 32 to the inside of the cab 16, and are manually inclined by an operator who is seated in the cab 16.

The first and the second control valve devices 33, 43 are attached, at a distance, in the front and rear directions of the mounting plate 32. That is, the first control valve device 33 is located at the rear position of the boom apparatus 18 that is near the coupling pin 7 (the base end side of the boom 19). The second control valve device 43 which is positioned in front of the first control valve device 33 is located at a front position that is nearer the body stabilization apparatus 24 (the stabilizer mounting portion 8, the cylinder mounting portion 9).

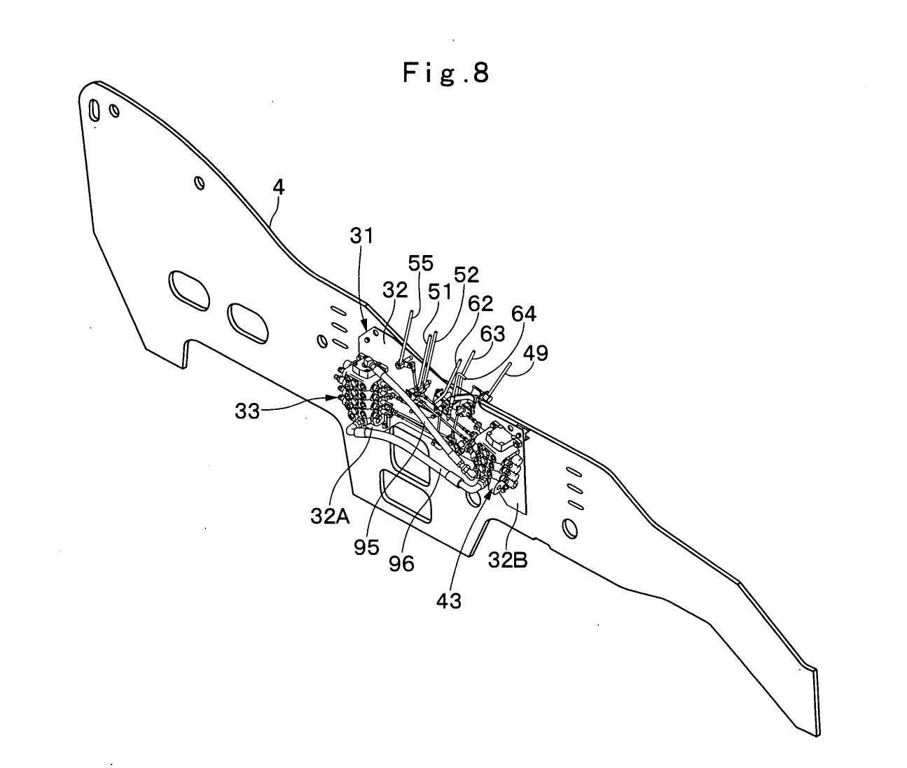

Reference numeral 32 denotes a mounting plate that constitutes the bracket of the lever/valve assembly 31. As shown in FIGS. 8 to 11, the mounting plate 32 is a flat plate made of flat steel, and is extended to the front and rear directions along the left vertical plate 4. The length of the mounting plate 32 to the front and the rear is about 100 to 130 cm, the width in the vertical direction is about 50 to 70 cm, and the thickness is about 4 to 8 mm.

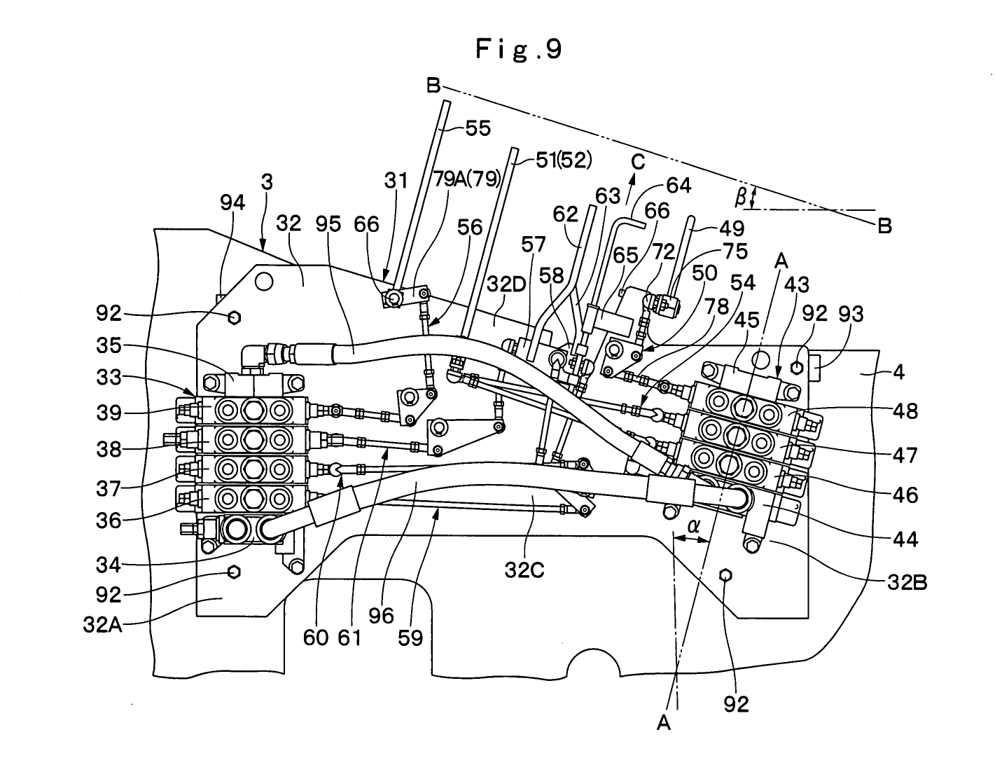

In this case, as shown in FIG. 9, provided for the mounting plate 32 are a first control valve mounting portion 32A located in front, a second valve mounting portion 32B located at the rear, a middle link mounting portion 32C located between the first and second control valve mounting portions 32A and 32B, and a lever mounting portion 32D located above the link mounting portion 32C.

The mounting plate 32 of the lever/valve assembly 31 is attachably or detachably installed on the inner wall of the left vertical plate 4 (the right side face of the left vertical plate 4 as viewed from the rear of the vehicle) by use of installation bolts 92 which will be described after. At this time, the control valve mounting portion 32A of the mounting portion 32 is located at a position nearer the rear of the vehicle, while the other control valve mounting portion 32B is located at a position nearer the front of the vehicle.

Reference numeral 33 denotes a first control valve device provided for the control valve mounting portion 32A of the mounting plate 32. As shown in FIGS. 9 and 10, the control valve device 33 is constituted by a lower joint plate 34 located on the lower side, an upper joint plate 35 located on the upper side, and the total four directional control valves 36, 37, 38, 39 used for a boom, which are laid between the joint plates 34, 35 as piled up state.

The joint plates 34, 35 and the boom directional control valves 36 to 39 of the control valve device 33 are vertically laid as shown in FIG. 9, and the side faces (the left side faces as viewed from the rear of the vehicle) are brought into contact with and secured to the control valve mounting portion 32A of the mounting plate 32 by using bolts.

In this case, for the control valve device 33, the directional control valves 36 to 39 are connected by use of a parallel circuit as shown in FIG. 21, and a center bypass line 33A is connected to the hydraulic pump 97, which will be described after, through a pump line 40.

The directional control valve 36 of the control valve device 33 performs the supply or discharge of pressure oil from the hydraulic pump 97, relative to the boom derricking cylinder 21 of the boom apparatus 18, so as to control the movement (extension and retraction) of the boom derricking cylinder 21.

Further, the directional control valve 37 of the control valve device 33 performs the supply and discharge of pressure oil from the hydraulic pump 97, relative to the boom extension cylinder 22, and permits the boom extension cylinder 22 to extend or retract the boom 19 in the longitudinal direction. Furthermore, the directional control valve 38 of the control valve device 33 performs the supply and discharge of pressure oil from the hydraulic pump 97, relative to the fork cylinder 23, so as to vertically turn the fork 20 at the distal end of the boom 19 shown in FIG. 1.

In this case, as shown in FIG. 21, a level cylinder 41 and the fork cylinder 23 are connected to the directional control valve 38 as parallel state. When the level cylinder 41 is extended or retracted in association with the boom derricking cylinder 21, the level cylinder 41 automatically corrects the posture of the fork 20 relative to the lifting up and down movement of the boom 19 in FIG. 1.

Therefore, the front and rear inclinations of the fork 20 of the boom apparatus 18 are corrected by the level cylinder 41, so that the distal end of the fork 20 is maintained almost horizontal when the boom 19 is vertically elevated. Further, the directional control valve 39 of the control valve device 33 is used to perform the supply and discharge of pressure oil from the hydraulic pump 97, relative to an extra hydraulic cylinder 42 in FIG. 21.

Reference numeral 43 is a second control valve device provided for the control valve mounting portion 32B of the mounting portion 32. As shown in FIGS. 9 and 10, the control valve device 43 is constituted by a lower joint plate 44 located at the lower side, an upper joint plate 45 located at the upper side, and directional control valves 46, 47 used for stabilizers and a directional control valve 48 used for tilt correction, which are laid between these joint plates 44, 45 as piled up state.

The joint plates 44, 45 and the directional control valves 46 to 48 of the control valve device 43 are vertically laid on each other, and their side faces (the left side faces as viewed from the rear of the vehicle) are brought into contact with and are secured to the control valve mounting portion 32B of the mounting plate 32 by using bolts. Further, for a reason that will be described after, as shown in FIG. 9, the directional control valves 46 to 48 of the control valve device 43 are located along a virtual line A-A that is inclined at an angle α from a line perpendicular to the vehicle.

In this case, in the control valve device 43, the directional control valves 46 to 48 are connected by use of a parallel circuit, as shown in FIG. 21, and a center bypass line 43A is connected to the center bypass line 33A of the first control valve device 33 via a hydraulic pipe 96.

And the directional control valves 46, 47 of the control valve device 43 perform the supply and discharge of pressure oil from the hydraulic pump 97, relative to the left and right stabilizer cylinders 26, 26 to control the movement (the extension and retraction) of the individual stabilizer cylinders 26.

Further, the directional control valve 48 of the control valve device 43 performs the supply and discharge of pressure oil from the hydraulic pump 97, relative to the tilt correction cylinder 28 to vertically extend or retract the tilt correction cylinder 28. The tilt correction cylinder 28 corrects the inclination of the vehicle body 2 shown in FIG. 1, so that the posture of the vehicle body 2 on a slope is stabilized.

Following this, reference numeral 49 denotes an operation lever used for tilt correction (hereinafter referred to as a correction lever 49), which is provided for the lever mounting portion 32D of the mounting plate 32, so as to be capable of being inclined. The correction lever 49 is manually inclined to the left or to the right, indicated by an arrow a in FIG. 11. Also, the correction lever 49 is coupled to the directional control valve 48 via the link mechanism 50 which is an operation transmission member, and switches the directional control valve 48.

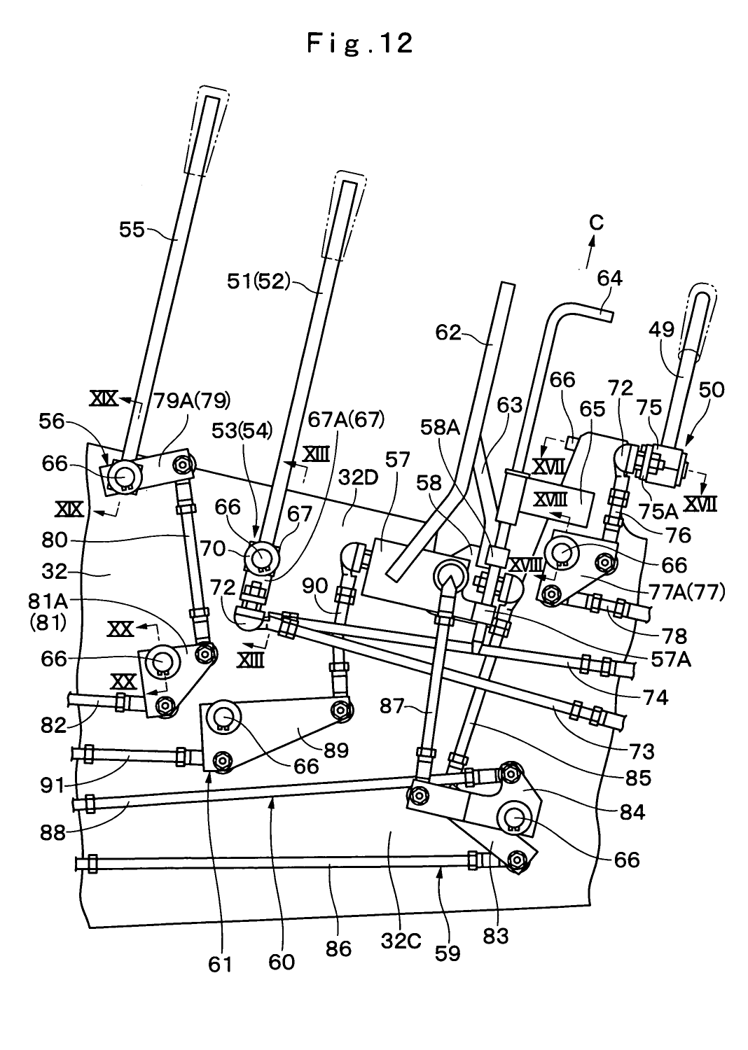

In this case, as shown in FIGS. 12, 17 and 18, the link mechanism 50 is constituted by a common support pin 66, spacers 70, stopper rings 71, an universal joint 72, rotary members 75, 77 and link rods 76, 78.

Reference numerals 51, 52 denote operation levers for stabilizers (hereinafter referred to as stabilizer operation levers 51, 52). The stabilizer operation levers 51, 52 are attached to the lever mounting portion 32D of the mounting plate 32, at a distance to the rear of the correction lever 49, so as to be susceptible to being inclined. Further, as shown in FIG. 11, the stabilizer operation levers 51, 52 are located nearer each other in the horizontal direction, and manually inclined independently to the front or to the rear, as indicated by an arrow b.

In this case, the stabilizer operation levers 51, 52 are coupled to the directional control valves 46, 47 individually by the link mechanisms 53, 54 which are operation transmission members. When the directional control valves 46, 47 are individually switched, the stabilizer operation levers 51, 52 independently move the left and right stabilizers 25, 25 shown in FIG. 1.

Further, when an operator in the vehicle inclines the stabilizer operation levers 51, 52 together, the left and right stabilizers 25, 25 are uniformly extended. Furthermore, as shown in FIGS. 12 to 15, the link mechanisms 53, 54 in this case are constituted by common support pins 66, rotary members 67, 68, spacers 70, stopper rings 71, universal joints 72 and link rods 73, 74.

Reference numeral 55 denotes an extra operation lever that is provided for the lever mounting portion 32D of the mounting plate 32, at a position to the rear of the stabilizer operation levers 51, 52, so as to be susceptible of being inclined. The operation lever 55 is linked to the directional control valve 39 of the first control valve device 33 through the link mechanism 56 which is an operation transmission member. And when the operation lever 55 is inclined to the front or to the rear directions (e.g., in the directions indicated by the arrow b in FIG. 11), the extra hydraulic cylinder 42 are operated as shown in FIG. 21.

Further, as shown in FIGS. 12, 19 and 20, the link mechanism 56, which is located between the operation lever 55 and the directional control valve 39, includes a common support pin 66, spacers 70, stopper rings 71, universal joints 72, rotary members 79, 81 and link rods 80, 82.

Reference numerals 57, 58 denote lever support members, which are provided for the lever mounting portion 32D of the mounting plate 32 at a position between the correction lever 49 and the stabilizer operation levers 51, 52. The lever support members 57, 58 are to be inclined by operation levers 62, 63 to the left or right directions and to the front or rear directions respectively.

In this case, when the operation levers 62, 63 are inclined to the front or to the rear directions (e.g., in the directions indicated by the arrow b in FIG. 11), the lever support members 57, 58 are inclined independently in the same direction. However, when the operation levers 62, 63 are inclined to the left or to the right directions (e.g., in the directions indicated by the arrow a in FIG. 11), the lever support members 57, 58 are integrally inclined in the same direction. Further, cylindrical shaped stoppers 57A, 58A which a lock lever 64 is to be removably inserted are provided for the lever support members 57, 58.

Reference numerals 59, 60, 61 denote link mechanisms that serve as operation transmission members attached to the link mounting portion 32C of the mounting plate 32. As shown in FIGS. 10 to 12, the link mechanisms 59 to 61 are arranged between the lever support members 57, 58 and the directional control valves 36, 37, 38 to transmit control of the operation levers 62, 63 to the directional control valves 36, 37, 38.

In order to couple the lever support member 58 with the directional control valve 36, the link mechanism 59 here is constituted by a common support pin 66, a rotary member 83 and link rods 85, 86. And the inclining movement of the lever support member 58 to the front or rear directions (e.g., the directions indicated by the arrow b in FIG. 11) by the operation lever 63 is transmitted to the directional control valve 36 via the link mechanism 59, so that the boom derricking cylinder 21 is controlled.

Furthermore, the link mechanism 60 is arranged between the lever support member 57 and the directional control valve 37, and is constituted by a common support pin 66, a rotary member 84 and link rods 87, 88. And the inclining movement of the lever support members 57, 58 to the left or right directions (e.g., the directions indicated by the arrow a in FIG. 11) by the operation lever 62 or 63 is transmitted to the directional control valve 37 via the link mechanism 60, so that the boom extension cylinder 22 is controlled.

In addition, the link mechanism 61 is arranged between the lever support member 57 and the directional control valve 38, and is constituted by a common support pin 66, a rotary member 89 and link rods 90, 91. And the inclining movement of the lever support member 57 to the front or rear directions (e.g., the directions indicated by the arrow b in FIG. 11) by the operation lever 62 is transmitted to the directional control valve 38 via the link mechanism 61, so that the fork cylinder 23 is controlled.

Reference numerals 62, 63 denote a pair of left and right operation levers, which are provided for the lever support members 57, 58 and are located in the middle position between the correction lever 49 and the stabilizer operation levers 51, 52. Of the operation levers 62, 63, the operation lever 62 is securely attached to the lever support member 57 and is coupled with the directional control valve 37 via the link mechanism 60, and is also coupled with the directional control valve 38 via the link mechanism 61.

The other operation lever 63 is securely attached to the lever support member 58, as shown in FIG. 11, and is coupled to the directional control valve 36 via the link mechanism 59, while the operation lever 63 is also linked to the directional control valve 37 via the lever support member 57 and the link mechanism 60.

Thus, when an operator of the vehicle inclines the operation lever 62 or the operation lever 63 to the left or to the right, either inclination manipulation is transmitted to the directional control valve 37 via the lever support member 57 and the link mechanism 60. Therefore, when one of the operation levers 62, 63 is manipulated to the left or to the right, the directional control valve 37 is switched, and the boom extension cylinder 22 is extended or retracted shown in FIG. 21.

Furthermore, when the operator inclines the operation lever 63 to the front or to the rear, this inclination manipulation is transmitted to the directional control valve 36 via the lever support member 58 and the link mechanism 59, and the boom derricking cylinder 21 is extended or retracted shown in FIG. 21. On the other hand, when the operator inclines the operation lever 62 to the front or to the rear, this inclination manipulation is transmitted to the directional control valve 38 via the lever support member 57 and the link mechanism 61, and the fork cylinder 23 is extended or retracted shown in FIG. 21.

Reference numeral 64 denotes a lock lever that constitutes a lock mechanism for locking the inclination manipulation of the operation levers 62, 63. As shown in FIGS. 10 and 11, the lock lever 64 is attached to the lever mounting portion 32D of the mounting plate 32 through a support arm 65, and located at a position between the correction lever 49 and the operation levers 62, 63.

And when the lock lever 64 is inserted (fitted) into the stoppers 57A, 58A of the lever support members 57, 58 at the lock position shown in FIG. 10, the lock lever locks the lever support members 57, 58, preventing any inclination of the operation levers 62, 63. Furthermore, when the lock lever is pulled up in the direction indicated by an arrow c in FIG. 10, the lock lever disengages the stoppers 57A, 58A, and permits the lever support members 57, 58 to be inclined together by the operation levers 62, 63.

As shown in FIG. 9, the second control valve device 43 (the directional control valves 46 to 48) is obliquely arranged along a virtual line A-A, which is inclined at an angle α from a line perpendicular to the vehicle. Further, the correction lever 49 and the operation levers 51, 52, 55, 62, 63 of the lever/valve assembly 31 are arranged so as to be inclined away from each other, as shown in FIGS. 8 to 12, while taking into account the usability to an operator in the cab 16.

Further, as shown in FIG. 9, the upper ends of the correction lever 49 and the operation levers 51, 52, 55, 62, 63 are raised from the front to the rear of the frame 3, and arranged along a virtual line B-B which is inclined at an angle β from a line horizontal to the vehicle.

In addition, as shown in FIGS. 9 to 12, the link mechanisms 50, 53, 54, 56, 59 to 61 are linked on the condition that their link joining portions (rotational points) are almost at a right angle, so that the link rods 73, 74, 78, 82, 86, 88, 91 are arranged to be positioned substantially linearly with the spools (not shown) of the directional control valves 46 to 48 and the directional control valves 36 to 39.

With this arrangement, the operating forces from the correction lever 49 and the operation levers 51, 52, 55, 62, 63 can be efficiently transmitted to the individual spools of the directional control valves 46 to 48 and the directional control valves 36 to 39 by the link mechanisms 50, 53, 54, 56, 59 to 61. And an equal spool moving distance can be obtained for each of the lever strokes that reciprocate as the correction lever 49 and the operation levers 51, 52, 55, 62, 63 are inclined.

An explanation will now be given for the common support pins 66 that are employed in common for the link mechanisms 50, 53, 54, 56, 59 to 61.

As shown in FIG. 16, a common support pin 66 is constituted by a shaft portion 66A having a large diameter and a small diameter portion 66B. For example, the total length is about 100 to 150 mm, and the outer diameter is 13 to 16 mm. The shaft portion 66A of the common support pin 66 has a length in the axial direction of 90 to 130 mm, so that rotary members 67, 68 can be inserted with being arranged in the axial direction.

Furthermore, in the outer face of the shaft portion 66A, four circumferential grooves 66C, 66D, 66E, 66F in total are formed at intervals in the axial direction, and constitute stopper mounting portions whereat the stopper rings 71, which will be described after, are to be selectively attached. For these circumferential grooves 66C to 66F, the interval between the circumferential grooves 66C, 66D is slightly greater than the lengths (sizes) in the axial direction of the rotary members 67, 68 and the interval between the circumferential grooves 66E, 66F is also slightly greater than the lengths (sizes) in the axial direction of the rotary members 67, 68. Further, the interval between the circumferential grooves 66D, 66E is slightly greater than the plate thickness (the size in the axial direction) of the spacer 70.

First, an explanation will be given for a case wherein such a common support pin 66 is employed for the link mechanisms 53, 54 shown in FIGS. 12 to 15.

In this case, the small diameter portion 66B of the common support pin 66 penetrates the mounting plate 32 (the lever mounting portion 32D) of the lever/valve assembly 31 and is fixed by welding. As a result, the common support pin 66 is attached to the lever mounting portion 32D of the mounting plate 32 in the cantilever state. Further, the common support pin 66 is also used as a common part for the other link mechanisms 50, 56, 59 to 61.

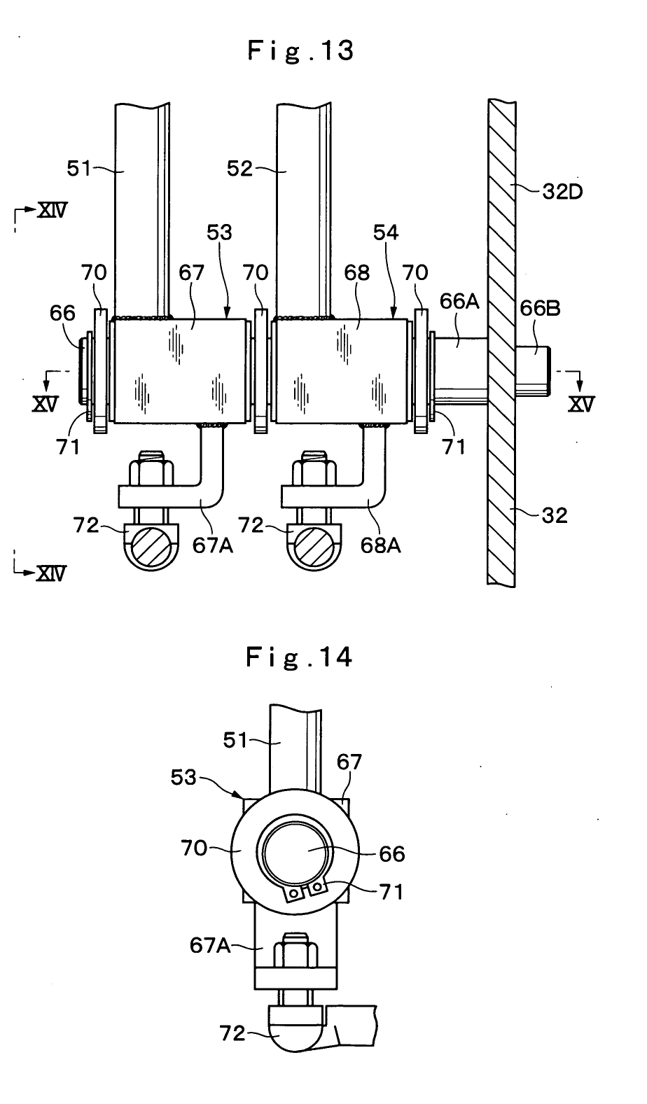

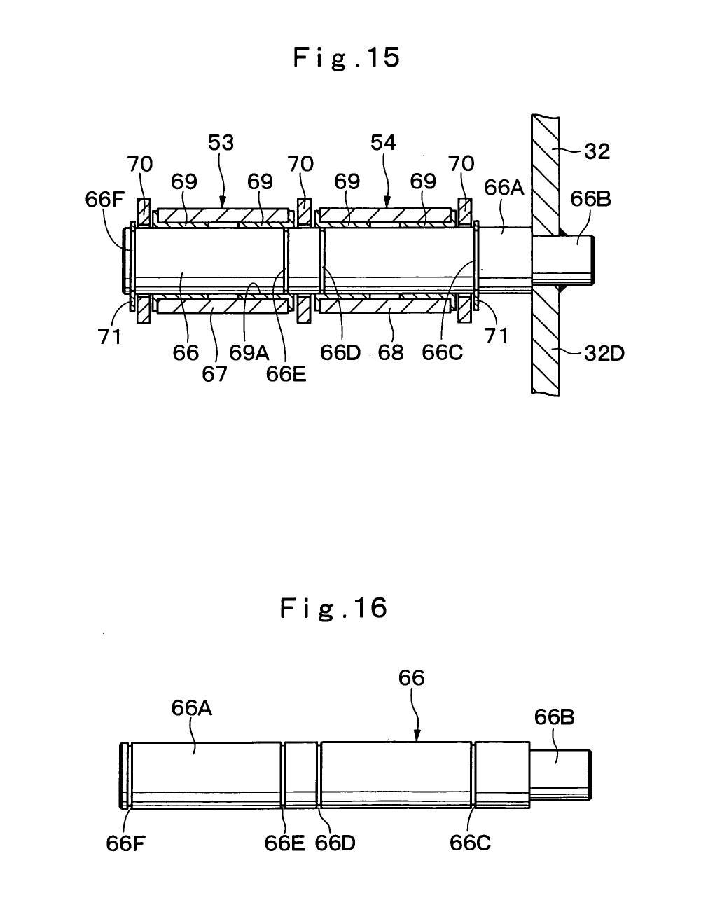

Reference numerals 67, 68 denote rotary members which serve as link members, that are fitted over the common support pin 66 while being arranged on the outer surface of the common support pin 66 in the axial direction. The rotary members 67, 68 are cylindrical body while the external shapes are square, as shown in FIGS. 13 and 14, and a pair of left and right collar bushes 69 are attached on the inner surface, as shown in FIG. 15. The inner surfaces of the collar bushes 69 serve as pin holes 69A that are fitted over the outer surface of the common support pin 66 (shaft portion 66A).

Furthermore, as shown in FIG. 13, the stabilizer operation levers 51, 52 are integrated with the rotary members 67, 68 by welding, and link levers 67A, 68A which are substantially L shaped project downward from the rotary members. Link rods 73, 74, which will be described after, are coupled with these link levers 67A, 68A via the universal joints 72.

Reference numerals 70 denote spacers that are fitted over the outer surface of the common support pin 66 with the rotary members 67, 68. These spacers 70 are made of ring-shaped flat plates having a predesignated thickness. The spacers 70 are used to adjust a gap in the axial direction between the rotary members 67, 68 on the outer surface of the common support pin 66, and also to adjust a gap in the axial direction between the stopper ring 71 and the rotary members 67, 68.

Reference numerals 71 denote stopper rings that serve as stopper tools that are selectively attached to the circumferential grooves 66C to 66F of the common support pin 66. On the outer surface of the common support pin 66, these stopper rings 71 prevent the slipping off of the individual rotary members 67, 68 together with the spacers 70. Furthermore, the smooth rotation (revolution) of the rotary members 67, 68, which are fitted over the outer surface of the common support pin 66 (shaft portion 66A) through the collar bushes 69, is ensured, relative to the shaft 66A, by the spacers 70 and the stopper rings 71.

Reference numerals 72 denote universal joints attached to the link levers 67A, 68A of the rotary members 67, 68. As shown in FIG. 12, these universal joints 72 are coupled with the ends of the link rods 73, 74 on one end, and as shown in FIG. 10, the other ends of the link rods 73, 74 are coupled with the directional control valves 46, 47, respectively. The directional control valves 46, 47 are separately switched via the link mechanisms 53, 54, by the stabilizer operation levers 51, 52.

The link mechanism 50 that couples the correction lever 49 with the directional control valve 48 will now be described.

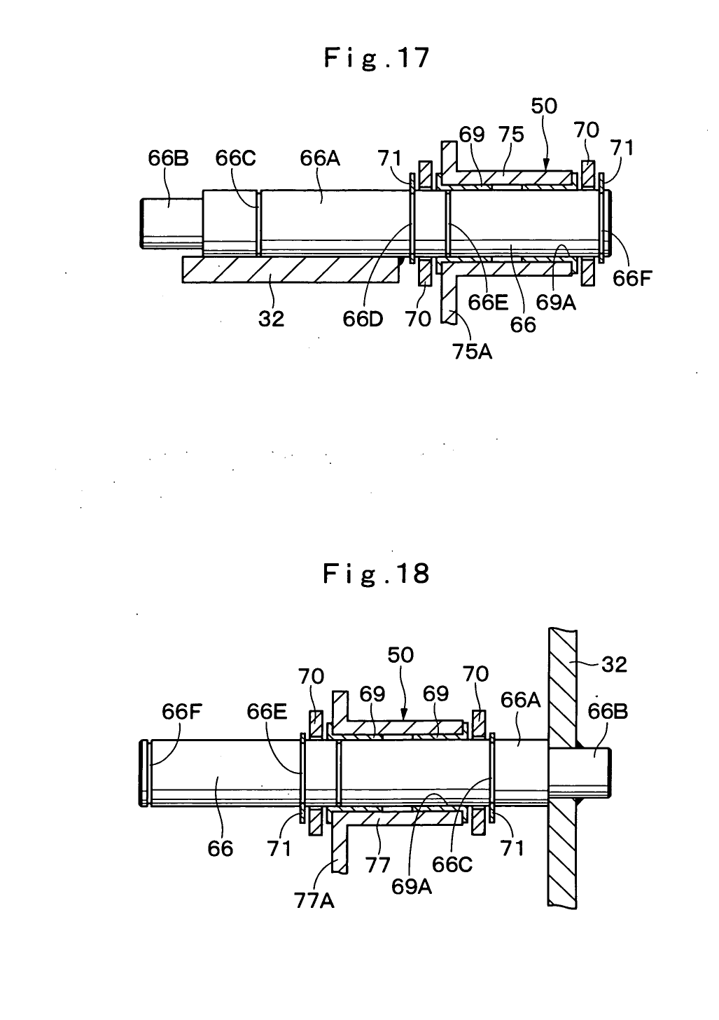

In this case, as shown in FIG. 12, two common support pins 66 are arranged vertically, at an interval. Firstly, as for the upper common support pin 66 where the rotary member 75 is to be inserted, as shown in FIG. 17, the end of the shaft portion 66A that is nearer the small diameter portion 66B is fixed to the reverse face of the mounting portion 32 by welding. And the upper common support pin 66 is extended in the longitudinal direction (the front and the rear directions of the vehicle) of the mounting plate 32 so as to ensure that the correction lever 49 is inclined to the left or right directions with the rotary member 75.

Likewise, as for the lower common support pin 66 wherein the rotary member 77 is to be inserted, as shown in FIG. 18, the small diameter portion 66B side is fixed to the mounting plate 32 in the cantilever state by welding.

Reference numeral 75 denotes a rotary member that serves as a link member fitted over the upper common support pin 66, and is constituted substantially in the same manner as the rotary member 67 of the link mechanism 53 described above. As shown in FIG. 17, collar bushes 69 are fitted (pushed in) along the inner surfaces. The stopper rings 71 which are mounted along the circumferential grooves 66D, 66F of the common support pin 66, hold the rotary member 75 on the outer surface of the common support pin 66 through the spacers 70, thereby the rotary member is prevented from slipping out.

In this case, as shown in FIG. 12, the correction lever 49 is integrated with the rotary member 75 by welding, and that the link lever 75A shaped like a flat plate is projected in the direction of the diameter of the common support pin 66. As further shown in FIG. 12, one end of the link rod 76 is connected to the link lever 75A through the universal joint 72, and the other end of the link rod 76 is rotatably connected to the link lever 77A of the rotary member 77, which will be described after.

Reference numeral 77 denotes a rotary member that serves as a link member fitted over the lower common support pin 66, and is constituted substantially in the same manner as the rotary member 68 of the link mechanism 54 described above. As shown in FIG. 18, collar bushes 69, 69 are fitted (pushed in) along the inner surface. The rotary member 77 is fitted over the outer surface via the individual collar bushes 69, while the rotary member is shifted near the base end side (one side in the axial direction) of the common support pin 66. Then, the stopper rings 71 attached along the circumferential grooves 66C, 66E of the common support pin 66, hold the rotary member on the outer surface of the common support pin 66 via the spacers 70, thereby the rotary member is prevented from slipping out.

It should be noted that in this case the link lever 77A, which is a flat plate having a substantially trapezoidal shape, is provided for the rotary member 77, and is projected in the direction of the diameter of the common support pin 66. And as shown in FIG. 12, other end of the link rod 76 is rotatably coupled with an end of the link lever 77A and one end of the link rod 78 is rotatably coupled with the other end (the lower side) of the link lever 77A.

In addition, the other end of the link rod 78 is coupled with the directional control valve 48, as shown in FIG. 10. Thus, the inclination control for the correction lever 49 is transmitted to the directional control valve 48 in FIG. 10 via the rotary member 75 (link lever 75A), the link rod 76, the rotary member 77 (link lever 77A) and the link rod 78 of the link mechanism 50 in FIG. 12.

An explanation will now be given for the link mechanism 56 that couples the operation lever 55 with the directional control valve 39.

As shown in FIGS. 12, 19 and 20, the link mechanism 56, as well as the previously described link mechanisms 53, 54, employs common support pins 66, spacers 70, stopper rings 71, universal joints 72 as common parts, and also includes rotary members 79, 81 and link rods 80, 82.

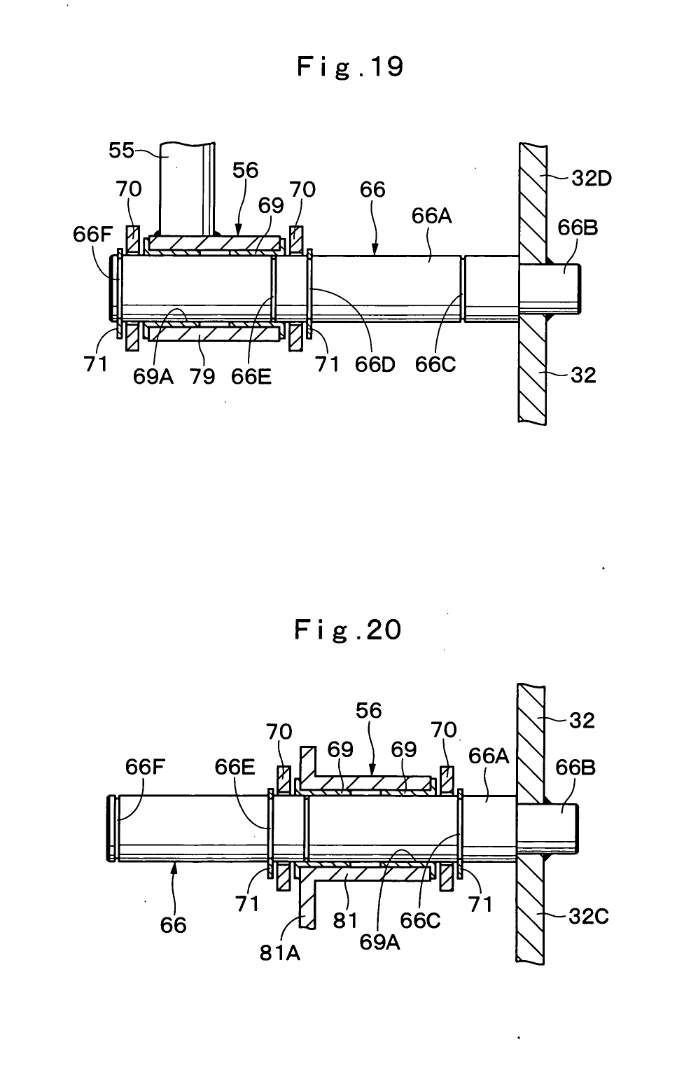

It should be noted that for the link mechanism 56 in this case, two common support pins 66 are vertically provided at an interval, as shown in FIG. 12. As for the upper common support pin 66 around which the rotary member 79 is to be fitted, as shown in FIG. 19, the small diameter portion 66B side is fixed to the mounting plate 32 by welding. Similarly, as for the lower common support pin 66 around which the rotary member 81 is to be fitted, as shown in FIG. 20, the small diameter portion 66B side is fixed to the mounting plate 32 by welding.

Reference numeral 79 denotes a rotary member that serves as a link member fitted over the upper common support pin 66, and is constituted substantially in the same manner as the rotary member 67 of the link mechanism 53 previously described. As shown in FIG. 19, collar bushes 69 are fitted (pushed in) along the inner surface. The rotary member 79 is fitted over the outer surface of the common support pin 66 via the collar bushes 69, while the rotary member is shifted to the distal end (the other side in the axial direction) of the common support pin 66. In addition, the stopper rings 71, 71, which are mounted along the circumferential grooves 66D, 66F of the common support pin 66, holds the rotary member 79 on the outer surface of the common support pin 66, via the spacers 70, 70, thereby the rotary member is prevented from slipping out.

It should be noted that, as shown in FIG. 12, the operation lever 55 is integrated with the rotary member 79 in this case by means such as welding, and that the link lever 79A shaped like a flat plate is projected in the direction of the diameter of the common support pin 66. Further, as shown in FIG. 12, one end of the link rod 80 is rotatably coupled with the link lever 79A, and the other end of the link rod 80 is rotatably coupled with the link lever 81A of the rotary member 81, which will be described after.

Reference numeral 81 denotes a rotary member that serves as a link member fitted over the lower common support pin 66, and is constituted substantially in the same manner as the rotary member 68 of the link mechanism 54, as previously described. As shown in FIG. 20, collar bushes 69, 69 are fitted (pushed in) along the inner surface. The rotary member 81 is fitted over the outer surface via the individual collar bushes 69, while the rotary member is shifted near the base end side (one side in the axial direction) of the common support pin 66. Moreover, the stopper rings 71, 71, which are mounted along the circumferential grooves 66C, 66E of the common support pin 66, hold the rotary member 81 on the outer surface of the common support pin 66, via the spacers 70, 70, thereby the rotary member is prevented from slipping out.

It should be noted that, in this case, the link lever 81A, a flat plate having a substantially trapezoidal shape as shown in FIG. 12, is provided for the rotary member 81, and is projected in the direction of the diameter of the common support pin 66. And as shown in FIG. 12, other end of the link rod 80 is coupled rotatably with one end of the link lever 81A, and one end of the link rod 82 is rotatably coupled with the other end (the lower side) of the link lever 81A.

In addition, the other end of the link rod 82 is coupled to the directional control valve 39, as shown in FIG. 10. Thus, the inclination control of the operation lever 55 is transmitted to the directional control valve 39 in FIG. 10 via the rotary member 79 (the link lever 79A), the link rod 80, the rotary member 81 (the link lever 81A) and the link rod 82 of the link mechanism 56 in FIG. 12.

Sequentially, an explanation will be given for the link mechanisms 59, 60 that couple the operation levers 62, 63 with the directional control valves 36, 37.

Reference numerals 83, 84 denote rotary members that serve as link members used for the link mechanisms 59, 60, and that constitute one part of the link mechanisms 59, 60 that couple the lever support members 57, 58 with the directional control valves 36, 37 as shown in FIG. 10. Further, substantially in the same manner as the rotary members 67, 68 shown in FIG. 13, the rotary members 83, 84 are fitted over the outer surface of a single common support pin 66, while being arranged in parallel in the axial direction.

In this case, as shown in FIG. 12, the rotary member 83 of the link mechanism 59 is rotatably coupled with the lever support member 58 via the link rod 85, and is also rotatably coupled with the directional control valve 36 in FIG. 10 via the link rod 86. With this arrangement, the operating movement of the operation lever 63 for the inclination of the lever support member 58 to the front or the rear directions (e.g., the directions indicated by the arrow b in FIG. 11), can be transmitted to the directional control valve 36 by the rotary member 83 via the link rods 85, 86.

Furthermore, as shown in FIG. 12, the rotary member 84 of the link mechanism 60 is rotatably coupled with the lever support member 57 via the link rod 87 and is also rotatably coupled with the directional control valve 37 in FIG. 10 via the link rod 88. With this arrangement, the operating movement of the operation lever 62 or 63 for the inclination of the lever support members 57, 58 to the front or right directions (e.g., the directions indicated by the arrow a in FIG. 11), can be transmitted to the directional control valve 37 by the rotary member 84 via the link rods 87, 88.

Following this, an explanation will now be given for the link mechanism 61 that couples the operation lever 62 with the directional control valve 38.

Reference numeral 89 denotes a rotary member 89 that serves as another link member, and that constitutes a part of the link mechanism that couples the lever support member 57 with the directional control valve 38 as shown in FIG. 10. The rotary member 89 is attached, after having been shifted near the base end side (one side in the axial direction) of the common support pin 66, in substantially the same manner as the rotary member 81 in FIG. 20.

As shown in FIG. 12, the rotary member 89 of the link mechanism 61 is rotatably coupled with the lever support member 57 via the link rod 90, and is rotatably coupled with the directional control valve 38 in FIG. 10 via the link rod 91. As a result, the operating movement performed using the operation lever 62 to incline the lever support member 57 to the front or rear directions (e.g., the directions indicated by the arrow b in FIG. 11), can be transmitted to the directional control valve 38 by the rotary member 89 via the link rods 90, 91.

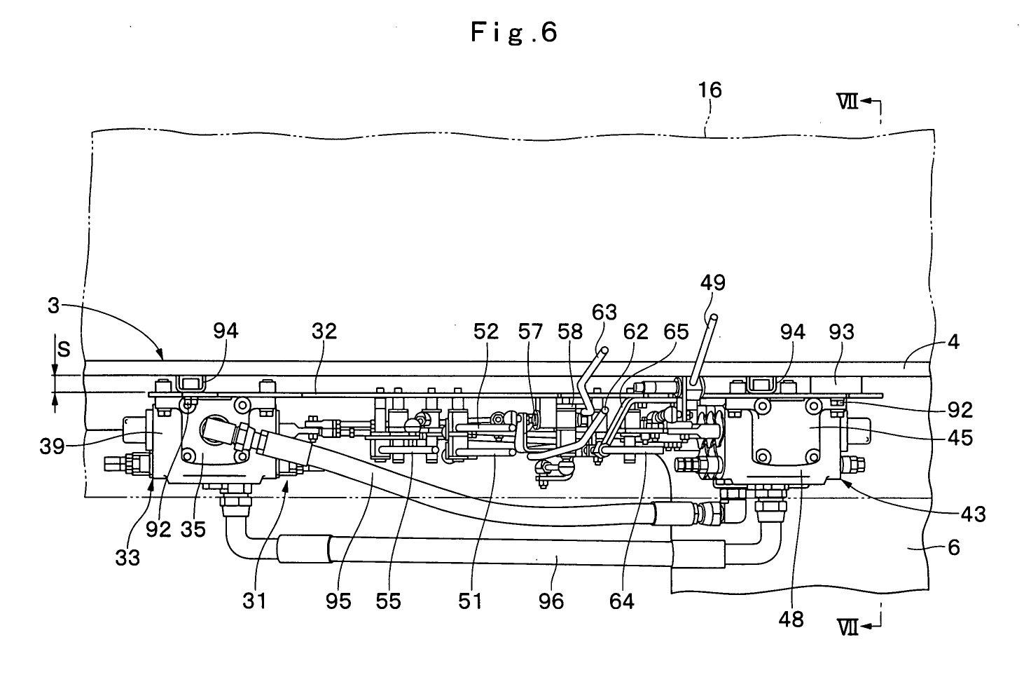

Reference numerals 92 denote installation bolts used to mount the lever/valve assembly 31 on the left vertical plate 4 of the frame 3. As shown in FIGS. 6 to 9, these installation bolts 92 are screwed into screw seats 93, 94 which are welded on the inner side face of the left vertical plate 4. Thus, the installation bolts 92 attachably or detachably secure the mounting plate 32 of the lever/valve assembly 31 to the left vertical plate 4.

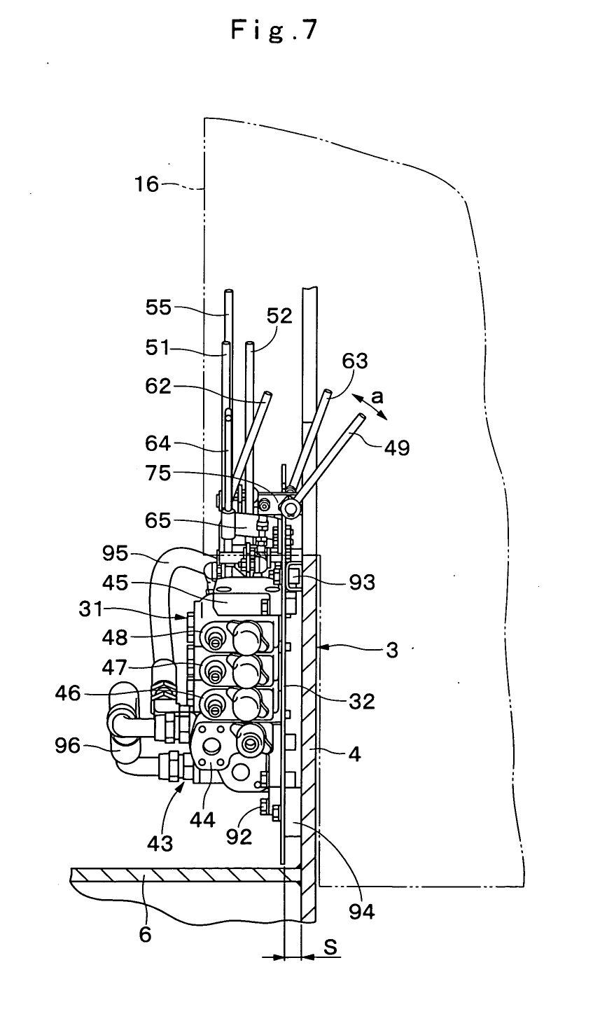

In this case, between the mounting plate 32 of the lever/valve assembly 31 and the left vertical plate 4, a gap S (e.g., about 20 to 30 mm) is defined by the screw seats 93, 94, as shown in FIGS. 6 and 7. The gap S has a function whereby heat from the control valve devices 33, 43 is externally discharged through the mounting plate 32.

Reference numerals 95, 96 denote hydraulic pipes that connect the first and second control valve devices 33, 43 of the lever/valve assembly 31, and that are located between the first control valve device 33 and the second control valve device 43, as shown in FIGS. 5 to 9. Of these two, the hydraulic pipe 95 connects the center bypass line 43A of the control valve device 43 to the center bypass line 33A of the control valve device 33, as shown in FIG. 21. The other hydraulic pipe 96 connects a low pressure side line 33B of the control device 33 with a low pressure side line 43B of the center bypass line 43A in FIG. 21 that is arranged downstream of the directional control valve 48. The hydraulic pipe 96 is connected via a hydraulic pipe 99 to an operating oil tank 98. Reference numeral 97 denotes a hydraulic pump that serves as a hydraulic source, together with the operating oil tank 98. The hydraulic pump 97 is located between the vertical plates 4, 5 in FIG. 5 and above the bottom plate 6, and is rotated by an engine (not shown) mounted on the device support portion 11. Further, the operating oil tank 98 is located, for example, outside the left vertical plate 4 and below the cab 16. As shown in FIG. 21, the hydraulic pump 97 sucks operating oil from the operating oil tank 98 and supplies pressure oil to the pump line 40 under high pressure. The supply and discharge of this pressure oil through the directional control valves 36 to 39 and 46 to 48 is performed relative to the individual cylinders 21 to 23, 42, 26, 28, and so forth.

Reference numeral 99 denotes another hydraulic pipe located between the low pressure side line 43B of the control valve device 43 and the operating oil tank 98. The hydraulic pipe 99 is also connected to the low pressure side line 33B of the control valve device 33 via the hydraulic pipe 96, and connects these low pressure side lines 33B, 43B to the operating oil tank 98.

The configuration of the lift truck 1 in this embodiment has been described, and the operation of the lift truck will now be described.

Firstly, when an operator who has entered the cab 16 of the lift truck 1 and has been seated in the operator's seat 17 starts the engine, the hydraulic pump 97 are rotated. Then, the supply and discharge of pressure oil forced out by the hydraulic pump 97 is performed relative to a driving hydraulic motor (not shown) for driving the front wheels 13 and the rear wheels 15, while the steering operation by using the handle is performed to steer the front wheels 13 and the rear wheels 15. As a result, the lift truck 1 is self-propelled while traveling to a work site.

Furthermore, when the lift truck 1 (vehicle) is to travel, the left and right stabilizers 25, 25 in FIG. 1 are elevated, and the respective ground plates 27 are positioned, widely separated from the ground to prevent the stabilizers 25 from interfering with the movement of the vehicle.

Next, when freight goods (not shown) is to be carried by the fork 20 of the boom apparatus 18 at a work site, the operator in the cab 16 grasps and pulls the lock lever 64 in the direction indicated by the arrow c in FIG. 9. As a result, since the lock lever 64 is disengaged from the stoppers 57A, 58A of the lever support members 57, 58, the lever support members 57, 58 can be inclined by using the operation levers 62, 63.

In this state, as the vehicle is moving forward slowly to freight goods, the fork 20 can be positioned to slide under the freight goods. Furthermore, at this time, when the operator in the cab 16 manually inclines the operation lever 62, the inclining of the operation lever 62 is transmitted via the lever support member 57 and the link mechanism 61 to the directional control valve 38.

Therefore, the directional control valve 38 can be changed from the neutral position shown in FIG. 21, and the supply and discharge of pressure oil by the hydraulic pump 97 can be performed for the fork cylinder 23, so that the fork cylinder 23 is driven in the extended direction. Then, when the fork cylinder 23 has been partially extended, for example, the fork 20 can be turned slightly, vertically, at the distal end of the boom apparatus 18 in FIG. 1, and the freight goods can be positioned on and stably supported by the fork 20.

In addition, when the work site is on a slope, for example, the operator in the cab 16 need only incline the correction lever 49 which serves as an operation lever for the correction of inclination, to change the directional control valve 48 which is coupled with the correction lever 49 via the link mechanism 50. When the directional control valve 48 is switched, the supply and discharge of pressure oil by the hydraulic pump 97 can be performed for the tilt correction cylinder 28. As a result, on the axle housing 14 on the front wheel 13 side in FIG. 1, the tilt correction cylinder 28 can be extended or retracted, so that the left or right tilting of the frame 3 can be corrected (frame leveling).

For a loading operation during which freight goods are carried to an elevated level (a high location) by using the boom apparatus 18 while the freight goods are borne by the fork 20, an external force that can overturn the vehicle may be applied due to the weight of the freight goods. In order to avoid overturning the vehicle, the left and right stabilizers 25, 25 must be positioned so they are extended further to the left and right than the respective stabilizer cylinders 26, as shown in FIG. 1.

In this case, therefore, the operator in the cab 16 inclines the stabilizer operation levers 51, 52. Through this operation, the operation forces produced by the operation levers 51, 52 are transmitted to the directional control valves 46, 47 via the link mechanisms 53, 54, so that the directional control valves 46, 47 are switched, and the left and right stabilizer cylinders 26, 26 are driven in the extended directions.

Through this operation, as shown in FIGS. 1 to 3, the individual stabilizers 25 of the lift truck 1 can be extended to the left and right directions by the stabilizer cylinders 26, and the ground plates 27 can be brought into contact with the ground. Thus, the stable state of the vehicle body 2 can be maintained during a loading operation, and the overturning of the vehicle body 2 can be provided.

Following this, when the boom apparatus 18 is to be operated in a state wherein the vehicle body 2 is stabilized, the operator in the cab 16 manipulates the operation levers 62, 63 while the lock lever 64 is disengaged, as described above. For example, when the operation lever 63 is inclined to the front or rear directions, this inclination is transmitted to the directional control valve 36 via the lever support member 58 and the link mechanism 59, and the boom derricking cylinder 21 in FIGS. 2 and 21 is extended or retracted, so that the boom 19 of the boom apparatus 18 can be lifted up and down vertically (hoisting).

When the operator in the cab 16 inclines the operation lever 62 or 63 to the left or right directions, either inclination is transmitted to the directional control valve 37 via the lever support member 57 and the link mechanism 60. And when the directional control valve 37 is switched, the boom extension cylinder 22 in FIGS. 1 to 3 and 21 is extended or retracted, so that the boom 19 of the boom apparatus 18 can be extended or retracted in the longitudinal direction.

In addition, when the operator inclines the operation lever 62 to the front or rear directions, this inclination is transmitted to the directional control valve 38 via the lever support member 57 and the link mechanism 61. Through this process, the fork cylinder 23 in FIGS. 2 and 21 is extended or retracted, and the fork 20 can be vertically turned, at the distal end of the boom apparatus 18, so that freight goods on the fork 20 can be carried to an appropriate location (an unloading place), as previously described.

When the unloading has been completed, the operator in the cab 16 inclines the operation lever 62 or 63 to retract the boom 19 of the boom apparatus 18. Further, by inclining the operation lever 63, the boom 19 is moved downward (descends). Through this operation, as shown in FIG. 1, the boom apparatus 18 can be positioned and stored on the frame 3.

As described above, according to this embodiment, as shown in FIGS. 10 and 11, the first control valve device 33 (the directional control valves 36 to 39), the second control valve device 43 (the directional control valve 46 to 48), the correction lever 49, the operation levers 51, 52, 55, 62, 63, the link mechanisms 50, 53, 54, 56, 59 to 61, and so forth, are mounted in advance on the mounting plate 32 to construct the lever/valve assembly 31.

As shown in FIGS. 4 to 9, the lever/valve assembly 31, which is preliminarily constructed in this manner, is to be attachably or detachably mounted on the left vertical plate 4, from inside the frame 3, by use of the mounting plate 32 and a plural number of installation bolts. Because of this arrangement, the operation for mounting the control valve devices 33, 43, the correction lever 49, the operation levers 51, 52, 55, 62, 63, the link mechanisms 50, 53, 54, 56, 59 to 61 on the frame 3 of the vehicle body 2 can be efficiently performed.

Specifically, since the preliminarily constructed lever/valve assembly 31 is attached via the mounting plate 32 to the left vertical plate 4 of the frame 3, unlike the conventional example, the process for attaching directional control valves to the frame and the process for mounting operation levers on the frame need not be performed separately. Furthermore, the mounting plate 32 of the lever/valve assembly 31 need only be mounted on the left vertical plate 4 of the frame 3, so that the control valve devices 33, 43, the correction lever 49, the operation levers 51, 52, 55, 62, 63 can be collectively mounted on the frame 3. As a result, the assembly work efficiency can be improved.

In addition, since the link mechanisms 50, 53, 54, 56, 59 to 61 are mounted in advance on the mounting plate 32 of the lever/valve assembly 31, when the lever/valve assembly 31 has been constructed, the operating state of the directional control valves 36 to 39, 46 to 48 can be easily confirmed relative to the inclination of the correction lever 49 and the operation levers 51, 52, 55, 62, 63.

Furthermore, in this case, fine adjustment can also be easily performed for the link mechanisms 50, 53, 54, 56, 59 to 61, which are provided for the link mounting portion 32C of the mounting plate 32. That is, for the link mechanisms 50, 53, 54, 56, 59 to 61, fine adjustments can be easily performed, for example, for the link length of the link rods 73, 74, 76, 78, 80, 82, 85 to 88, 90, 91, and the movements of the individual links can be smoothly adjusted.

And by employing these link mechanisms 50, 53, 54, 56, 59 to 61, fine adjustments can be easily made for the movements of the directional control valve 36 to 39 and the directional control valves 46 to 48. Further, such a fine adjustment operation can be easily performed from outside the vehicle body 2, e.g., in a large work space, such as an assembly plant.

That is, the adjustment for smoothing the movements of the link mechanisms 50, 53, 54, 56, 59 to 61 can be easily performed in a large work space when the lever/valve assembly 31 has been preliminarily constructed. Furthermore, at this preliminary assembly stage, fine adjustments for the movements of the directional control valves 36 to 39, 46 to 48 can also be easily performed.

After the fine adjustments have been made the movements of the directional control valves 36 to 39, 46 to 48, the lever/valve assembly 31 can be fixed to the inner side face of the left vertical plate 4 of the frame 3, in the transverse direction (the direction from either the left or the right) by use of the mounting plate 32 and installation bolts 92. As a result, the process for mounting the lever/valve assembly 31 on the frame 3 of the vehicle body 2 can be smoothly performed, and the efficiency of the assembly operation can be improved.

In addition, the lever/valve assembly 31 is designed by the following construction, namely the link mechanisms 50, 53, 54, 56, 59 to 61 are mounted on the single mounting plate 32, together with the correction lever 49, the operation levers 51, 52, 55, 62, 63 and the directional control valves 36 to 39, 46 to 48. Therefore, the entire lever/valve assembly 31, which includes the first control valve device 33 (the directional control valves 36 to 39) and the second control valve device 43 (the directional control valves 46 to 48), can be made compactly, and assembly errors can also be reduced.

Therefore, according to this embodiment, since the first and the second control valve devices 33, 43, the correction lever 49, the operation levers 51, 52, 55, 62, 63, the link mechanisms 50, 53, 54, 56, 59 to 61 are attached in advance to the single mounting plate 32 to construct the lever/valve assembly 31, the assembly operation for the control valve devices 33, 43 and the operation levers 51, 52, 55, 62, 63 can be efficiently performed. As a result, the efficiency of the vehicle assembly operation can be considerably increased.

In addition, the cab 16 into which the operator gets in and out is provided with the left vertical plate 4 on which the lever/valve assembly 31 is mounted, and the correction lever 49, the operation levers 51, 52, 55, 62, 63 are arranged inside the cab 16. Thus, the usability to the operator in the cab 16 can be improved.

That is, an operator in the cab 16 can switch the directional control valves 36 to 39, 46 to 48 by manually inclining the correction lever 49 and the operation levers 51, 52, 55, 62, 63, so that the supply and discharge control (operation) of pressure oil for the individual cylinders 21 to 23, 26, 28, 42 can be smoothly performed.

Moreover, according to this embodiment, the first control valve device 33, which includes the directional control valves 36 to 39 used for a boom, and the second control valve device 43, which includes the directional control valves 46, 47 used for stabilizers and the directional control valve 48, are provided at an interval toward the front and the rear of the left vertical plate 4 by use of the mounting plate 32. In addition, the first control valve device 33 is located at a position near the coupling pin 7 (near the base end of the boom 19) of the boom apparatus 18, while the second control valve device 43 is located at a position near the body stabilization apparatus 24 (the stabilizer mounting portion 8 and the cylinder mounting portion 9).

Thus, the lengths of the individual hydraulic pipes, which connect the first control valve device 33 (the directional control valves 36 to 39) to the cylinders 21 to 23, 41, 42 of the boom apparatus 18, can be shorter than those of the conventional examples. Further, the lengths of the individual hydraulic pipes, which connect the second control valve device 43 (the directional control valves 46 to 48) and the cylinders 26, 28 of the body stabilization apparatus 24, can also be actually shortened.

In addition, one of the hydraulic pipes, which is to be connected to the first control valve device 33 (the directional control valves 36 to 39), is arranged toward the rear from the position of the control valve device 33 in order to be extended to the cylinders 21 to 23, 41, 42 of the boom apparatus 18. The other hydraulic pipe, which is to be connected to the second control valve device 43 (the directional control valves 46 to 48), is arranged toward the front from the position of the control valve device 43 in order to be extended to the cylinders 26, 28 of the body stabilization apparatus 24.

Therefore, the individual hydraulic pipes thus arranged will not contact or interfere with the link mechanisms 50, 53, 54, 56, 59 to 61 which are located between the directional control valves 36 to 39 and the directional control valves 46 to 48. As a result, the movements of the link mechanisms 50, 53, 54, 56, 59 to 61 can be protected from being adversely affected by the pulsating motion of pressure oil that flows through the hydraulic pipes, and the stable movement of the individual links can be maintained.

Furthermore, according to this embodiment the length can be shortened for one hydraulic pipe that connects the first control valve device 33 and the individual cylinders 21 to 23, 41, 42 of the boom apparatus 18, and for the other hydraulic pipe that connects the second control valve device 43 to the cylinders 26, 28 of the body stabilization apparatus 24. Therefore, the number of pipe hooks (not shown) can be reduced that are used at the positions en route in the longitudinal direction of each hydraulic pipe, and the number of parts can be reduced. Thus, the hydraulic piping operation can be simplified, and the vehicle assembly work efficiency can be improved.

Moreover, the lock lever 64 for regulating the manipulation of the operation levers 62, 63 are provided for the mounting plate 32 of the lever/valve assembly 31. As a result, the lock lever 64 can be included in the lever/valve assembly 31 constituted by the control valve devices 33, 43 and the operation levers 51, 52, 55, 62, 63.

When the lock lever 64 is included, the entire lever/valve assembly 31 can be compactly made. Further, when the lock lever 64 is operated, erroneous operations of the operation levers 62, 63 can be prevented, so that operating safety is ensured and reliability is increased.

Furthermore, according to this embodiment, of the plural number of link mechanisms 50, 53, 54, 56, 59 to 61 described above, the rotary members 67, 68, for example, of the link mechanisms 53, 54 shown in FIGS. 13 to 15 are fitted over the outer surface of the common support pin 66 that is supported by the mounting plate 32 in a cantilever manner, while the rotary members are arranged in line in the axial direction (first usage form). The rotary member 77 of the link mechanism 50 in FIG. 18 is fitted over the outer surface of the common support pin 66 that is supported by the mounting plate 32 in the cantilever manner, while the rotary member is shifted to one side in the axial direction (near the base end of the common support pin 66) (second usage form).

The rotary member 79 of the link mechanism 59 in FIG. 19 is fitted over the outer surface of the common support pin 66 that is supported by the mounting plate 32 in the cantilever manner, while the rotary member is shifted to the other side in the axial direction (near the distal end of the common support pin 66) (third usage form). The rotary member 81 of the link mechanism 56 in FIG. 20 is fitted according to the second usage form where the rotary member is shifted to near the base end of the common support pin 66.

As described above, regardless of the first to the third usage forms, the single common support pin 66 can be used as a common part. Also for the other link mechanisms 59, 60, 61, the rotary members 83, 84, 89 in FIG. 12 can be fitted over the respective common support pins 66 by selecting one of the previously described first to third usage forms.

Furthermore, as a usage form for the common support pin 66, like the common support pin 66 that the rotary member 75 in FIG. 17 is fitted over, the outer surface of the shaft portion 66A that is near the small diameter portion 66B may be fixed to the reverse face of the mounting plate 32 by welding.

Therefore, since the common support pin 66, the spacers 70 and the stopper rings 71 are employed as common parts for the plural number of link mechanisms 50, 53, 54, 56, 59 to 61, the number of parts can be reduced, and parts management can be simplified. As a result, the erroneous assembly of the common support pin 66 can be prevented, and extra labor and time are not required for the process for attaching the common support pin 66. Therefore, the efficiency of the assembly operation can be improved.

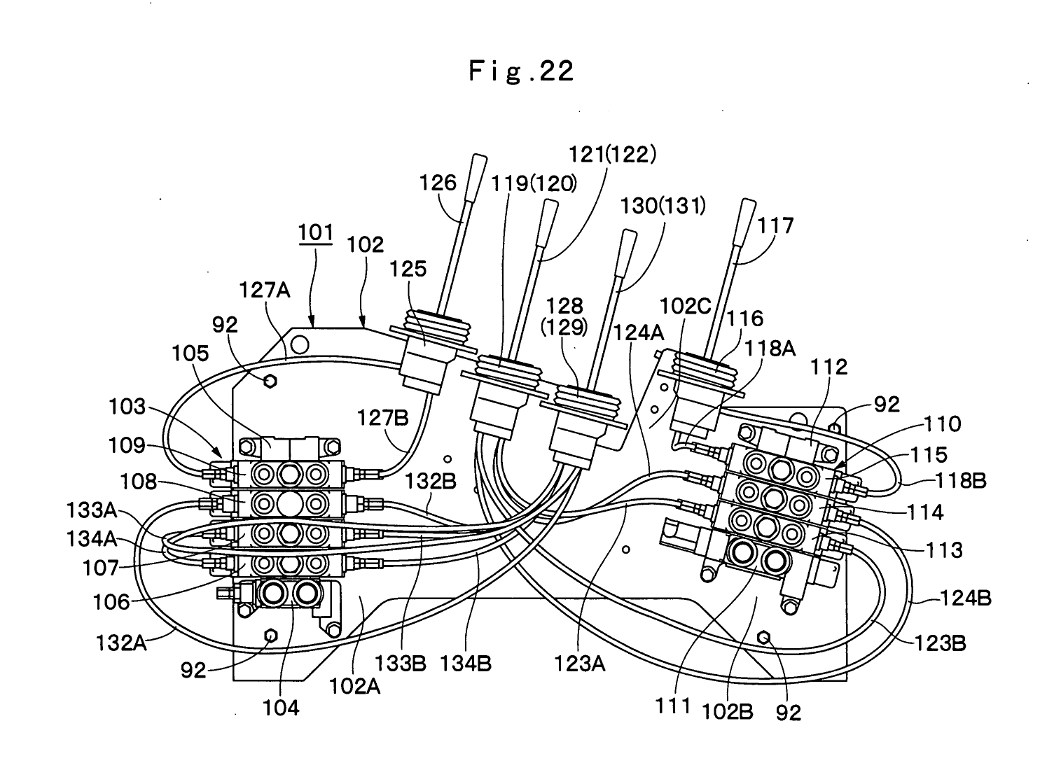

Next, a second embodiment of the present invention is shown in FIG. 22, and the characteristic of this embodiment is an arrangement wherein operating valves of a hydraulic pilot type are employed to switch directional control valves. It should be noted that, in this embodiment the same reference numerals are provided for the same components as those in the first embodiment described above, and no further explanation for them will be given.

In the drawings, reference numeral 101 denotes a lever/valve assembly that is adopted for this embodiment, and is constructed substantially in the same manner as is the lever/valve assembly 31 described in the first embodiment. First and second control valve devices 103, 110, which will be described after, and pressure reducing valve type pilot operating valves 116, 119, 120, 125, 128, 129 are provided for a mounting plate 102 that serves as a bracket.

The mounting plate 102 of the lever/valve assembly 101 has almost the same shape as that of the mounting plate 32 described in the first embodiment. However, provided for the mounting plate 102 in this embodiment are first and second control valve mounting portions 102A, 102B that are located on either side in the front and rear directions, and an operating valve mounting portion 102C that is located at the upper side.

Reference numeral 103 denotes a first control valve device that is attached to the control valve mounting portion 102A of the mounting plate 102, and that is constructed substantially in the same manner as the control valve device 33 described in the first embodiment. That is, the control valve device 103 includes lower and upper joint plates 104, 105, and a total of four directional control valves 106, 107, 108, 109, which are arranged as though piled up each other between the joint plates 104, 105. However, the control valve device 103 in this case is different in that the directional control valves 106 to 109 are constituted by a hydraulic pilot type directional control valves.

Reference numeral 110 denotes a second control valve device that is provided for the control valve mounting portion 102B of the mounting plate 102, and that is constructed substantially in the same manner as the control valve device 43 described in the first embodiment. That is, the control valve device 110 includes lower and upper joint plates 111, 112, and a total of three directional control valves 113, 114, 115, which are piled up each other between these joint plates 111, 112. However, the control valve device 110 in this case is different in that the directional control valves 113 to 115 are constituted by a hydraulic pilot type directional control valves.

Reference numeral 116 denotes a pilot operating valve that serves as signal output means provided for the operating valve mounting portion 102C of the mounting plate 102. A correction lever 117, which is substantially the same as the correction lever 49 (the operation lever for tilt correction) described in the first embodiment, is operatably provided for the pilot operating valve 116. Further, the output side of the pilot operating valve 116 is connected to the directional control valve 115 via a pair of pilot pipes 118A, 118B that serve as signal transmission means.

When, a pilot pressure that is consonant with the inclining operation of the correction lever 117, is transmitted from the pilot operating valve 116 to the directional control valve 115 via the pilot pipes 118A, 118B, the directional control valve 115 is switched in consonance with the inclination of the correction lever 117.

Reference numerals 119, 120 denote pilot operating valves that are provided as another signal output means for the operating valve mounting portion 102C of the mounting plate 102. Operation levers 121, 122, which are substantially the same as the stabilizer operation levers 51, 52 described in the first embodiment, are operatably provided for the pilot operating valves 119, 120. Further, the output side of the pilot operating valve 119 is connected to the directional control valve 113 via pilot pipes 123A, 123B that are signal transmission means. The output side of the pilot operating valve 120 is connected to the directional control valve 114 via pilot pipes 124A, 124B that are signal transmission means.

When pilot pressures that are consonant with the inclination operations of the operation levers 121, 122, is transmitted from the pilot operating valves 119, 120 to the directional control valves 113, 114, these directional control valves 113, 114 are switched in consonance with the inclination operation of the operation levers 121, 122.

Reference numeral 125 denotes a pilot operating valve that is provided as another signal output means for the operating valve mounting portion 102C of the mounting plate 102. An operation lever 126, which is substantially the same as the operation lever 55 described in the first embodiment, is openatably provided for the pilot operating valve 125. Further, the output side of the pilot operating valve 125 is connected to the directional control valve 109 via pilot pipes 127A, 127B, which are signal transmission means.

When a pilot pressure that is consonant with the inclination operation of the operation lever 126, is transmitted from the pilot operating valve 125 to the directional control valve 109 via the pilot pipes 127A, 127B, the directional control valve 109 is switched in consonance with the inclination of the operation lever 126.

Reference numerals 128, 129 denote pilot operating valves that are provided as other signal output means for the operating valve mounting portion 102C of the mounting plate 102. Operating levers 130, 131, which are substantially the same as the operation levers 62, 63 described in the first embodiment, are openatably provided for the pilot operating valves 128, 129.

Furthermore, the output side of the pilot operating valve 128 is connected to the directional control valve 108 via pilot pipes 132A, 132B, which are signal transmission means, and is also connected to the directional control valve 107 via pilot pipes 133A, 133B, which are signal transmission means. The output side of the pilot operating valve 129 is connected to the directional control valve 106 via pilot pipes 134A, 134B, which are signal transmission means, and is also connected to the directional control valve 107 via the pilot pipes 133A, 133B.

When the operation levers 130, 131 are inclined to the front or rear directions, the pilot operating valves 128, 129 supply a pilot pressure to the directional control valves 108, 106, and independently switch the directional control valves 108, 106. Further, when the operation levers 130, 131 are inclined to the left or right directions, the pilot operating valves 128, 129 supply to the directional control valve 107 a pilot pressure that is consonant with either inclination operation, and switches the directional control valve 107.

Therefore, according to this embodiment as thus arranged, the lever/valve assembly 101 can be constructed by using the control valve devices 103, 110, and the pilot operating valves 116, 119, 120, 125, 128, 129, and almost the same operating effects as obtained in the first embodiment can be acquired. Further, the first control valve device 103 which includes the directional control valves 106 to 109, and the second control valve device 110 which includes the directional control valves 113 to 115, can be attached through the mounting plate 102 at an interval toward the front and the rear of the frame 3 (the left vertical plate 4).

Especially in this embodiment, the pilot operating valves 116, 119, 120, 125, 128, 129 which serve as signal output means, and the directional control valves 106 to 109, 113 to 115 can be connected by the pilot pipes 118A, 118B, 123A, 123B, 124A, 124B, so that the link mechanisms 50, 53, 54, 56, 59 to 61 described in the first embodiment are not required.

In the explanation for the second embodiment, the directional control valves 106 to 109, 113 to 115 have been regarded as a hydraulic pilot type directional control valve, and the pilot operating valves 116, 119, 120, 125, 128, 129 have been employed as example signal output means. However, the present invention is not limited to this, and directional control valves, for example, may be proportional solenoid control valves, and electric levers may be employed as signal output means.

In addition, in the explanation for the first embodiment, the link mechanisms 50, 53, 54, 56, 59 to 61 have been employed as example operation transmission members for the lever/valve assembly 31. However, the present invention is not limited to this, and an operation transmission member made of push-pull wire may be employed to transmit the manipulation of the operation levers to the directional control valves.

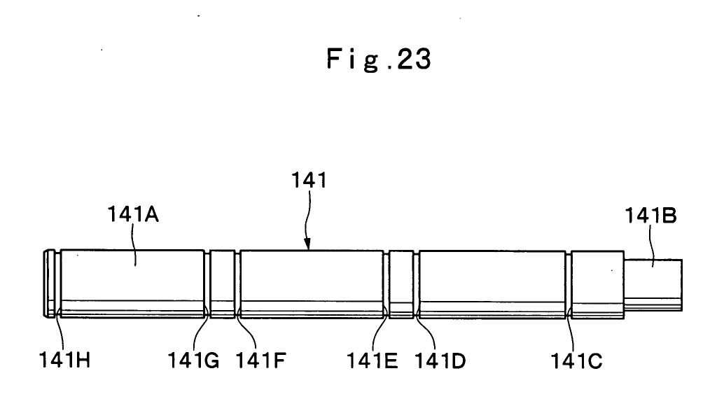

Further, in the explanation for the first embodiment, as an example, the common support pins 66 used as common parts have been formed having a length such that two link members (e.g., the rotary members 67, 68) can be arranged in line in the axial direction. However, the present invention is not limited to this, and a common support pin 141 according to a modification shown in FIG. 23 is also available. The common support pin 141 may be formed with a length that permits three link members to be fitted, while arranged in line in the axial direction.

That is, according to the modification shown in FIG. 23, as well as the common support pin 66 described in the above embodiment, the common support pin 141 is constituted by a shaft portion 141A having a large diameter and a small diameter portion 141B. However, for the common support pin 141 in this case, the shaft portion 141A is elongated, and in the axial direction has a length that permits three link members (e.g., the rotary members 67, 68) to be fitted over the common support pin, while arranged in line in the axial direction. Therefore, on the outer surface of the shaft portion 141A, for example, a total of six circumferential grooves 141C, 141D, 141E, 141F, 141G, 141H are formed at intervals in the axial direction.

In addition, in the explanation for the first embodiment, as an example, the pair of left and right collar bushes 69, 69 have been fitted along the inner surfaces of the rotary members 67, 68, which serve as link members. However, the present invention is not limited to this, and as an example, a common support pin may be inserted through a roller bearing into the inner surfaces (pin holes) of the link members of the rotary members 67, 68.

Whereas in the explanation for the first embodiment, as an example, the first and second control valve devices 33, 43 have been mounted on the mounting plate 32 of the lever/valve assembly 31 at an interval toward the front and rear directions. However, the present invention is not limited to this, for example, one or more directional control valves and one or more operation levers which switch the directional control valves, may be attached to a single bracket (one mounting plate) to construct the lever/valve assembly. And a plural number of directional control valves may be constructed as a control valve device serving as a single block. This also applies for the second embodiment.

Moreover, in the explanation for the individual embodiments, the lift truck 1 used for a loading operation has been employed as an example working machine. The present invention, however, is not limited to this, and can be widely applied for another working machine, such as a hydraulic excavator, a hydraulic crane or a wheel loader, that includes a boom apparatus wherein a hydraulic actuator for a boom is operated by switching directional control valves by use of operation levers.

1. A working machine comprised of a frame constituting a mobile vehicle body and extending from the front to the rear, a boom apparatus provided for said frame and operated by a plural number of hydraulic boom actuators, a plural number of directional control valves controlling an operation of said boom apparatus by supply or discharge of pressure oil relative to said individual hydraulic actuators, and a plural number of operation levers switching the individual directional control valves in order to control the supply and discharge of pressure oil relative to said individual hydraulic actuators, and said frame is constituted by a pair of vertical plates which are separated to the left and right sides and extended from the front to the rear directions, and a bottom plate which couples said pair of vertical plates in the left and right direction, characterized in that:
said operation levers and said direction control levers are mounted to a bracket that is a mounting plate to construct a lever/valve assembly; and
said lever/valve assembly is mounted to be attachable to or detachable from one of said pair of vertical plates constituting said frame by the use of said bracket along the front and rear directions.

2. A working machine as defined in claim 1, wherein the base end of said boom apparatus is provided liftably up and down at the rear portion of said frame, a stabilizer apparatus which is to be operated by a hydraulic stabilizer actuator is provided at the front portion of said frame, directional control valves which control said boom hydraulic actuators are located at the rear portion of said bracket in the vicinity of the position whereat said boom apparatus is mounted, and a directional control valve which controls said hydraulic stabilizer actuator is located in front of said bracket in the vicinity of the position whereat said stabilizer apparatus is attached.

3. A working machine as defined in claim 1, wherein a tilt correction hydraulic cylinder is provided on the front side of said frame in order to correct the left or right tilting of said vehicle body, and a directional control valve controlling said tilt correction hydraulic cylinder is located in front of said bracket.

4. A working machine as defined in claim 1, wherein said lever/valve assembly includes an operation transmission member attached to said bracket and located between said operation levers and said directional control valves, and said operation transmission member couples said operation levers with said directional control valves to transmit the operation force of said operation levers toward said directional control valves.

5. (canceled)

6. A working machine as defined in claim 1, wherein an operator cab used when manipulating said operation levers is provided for one of said vertical plates to which said lever/valve assembly is attached.

7. A working machine as defined in claim 1, wherein a lock mechanism restricting the control of said operation levers is provided for said bracket of said lever/valve assembly.

8. A working machine as defined in claim 1, wherein a plural number of link mechanisms having a plural number of support pins are provided for said bracket between each of said operation levers and each of said directional control valves, and said support pins rotatably support a plural number of link members which transmit the operating force of said operation levers to said directional control valves; and
said support pins of said individual link mechanisms have an axial length equivalent to a length that permits a plural number of said link members to be inserted in a row in an axial direction, and are constituted as common support pins used in common to support one or a plural number of said link members.

9. A working machine as defined in claim 1, wherein said bracket constituting of said lever/valve assembly is provided with a plural number of signal output means for outputting signals consonant with manipulation of said individual operation levers, and a plural number of signal transmission means for transmitting signals from said respective signal output means to said directional control valves and for switching said directional control valves individually.
